(19) United States
(12) Patent Application Publication
(10) Pub. No.: US 2016/0180248 A1
(43) Pub. Date: Jun. 23, 2016

(54) CONTEXT BASED LEARNING

(71) Applicant: PEDER REGAN, New York, NY (US)

(72) Inventor: PEDER REGAN, New York, NY (US)

(21) Appl. No.: 14/831,207

(22) Filed: Aug. 20, 2015

Related U.S. Application Data
(60) Provisional application No. 62/040,142, filed on Aug. 21, 2014.

(51) Int. Cl. G06N 99/00; G06N 5/04

(52) U.S. Cl. CPC G06N 99/005; G06N 5/04

(57) ABSTRACT

A learning system including a memory storing a computer program; a network interface configured to communicate with remote access devices across a computer network; and a processor configured to execute the computer program, wherein the computer program is configured to perform a cluster analysis on groups of users, to predict for each group, a subset of training modalities from among a larger set of learning modalities where the corresponding group has a greater than average rate of improvement in a given skill among a plurality of available skills over a given time period, wherein the computer program is configured to perform a cluster analysis on a new user and the groups of users to determine one group among the groups the user is most similar to, and wherein the computer program is configured to present training material across the network on the remote access device of the new user based on the predicted subset of the learning modalities associated with the determined one group.

### CROSS-REFERENCE TO RELATED APPLICATION

The present application is based on provisional application Ser. No. 62/040,142 filed on Aug. 21, 2014, the entire contents of which are herein incorporated by reference.

### BACKGROUND

1. Technical Field

The present disclosure relates generally to learning, and more particularly to systems and methods to train learners based on context information.

2. Discussion of Related Art

Computer-Based Learning systems and other forms of electronically supported learning and teaching (generically referred to as e-Learning systems) have traditionally relied on one-size-fits all learning materials, with identical course modules completed by all learners. Independent of their format, these systems traditionally follow a fixed curriculum, where a predefined sequence of modules is prescribed for groups of individuals.

### SUMMARY OF THE INVENTION

An exemplary embodiment of the invention is an adaptive learning system that tracks learner interactions with educational content over multiple dimensions of learning and uses multiple statistical models and data analysis techniques to create personalized curricula for each learner and continuously evaluate and adjust curricula on a near-real-time basis.

The system takes an evolutionary approach to the learner/content relationship, allowing for the continuous reevaluation of content in response to learner interaction as well as evaluation of the learner in response to content interaction.

The system allows for input from human influencers as well as internal and external data sources.

The system normalizes data from multiple content modalities, allowing for the use and comparison of non-homogenous modalities.

The system utilizes a large library of educational content modalities that are ranked using multiple models.

In a Learning Effectiveness Estimation model, the system first chooses a strong binary success signal, such as meeting sales goals or receiving a promotion, then trains a logistic regression model as a predictor of success using many aggregate features, such as total time spent in learning activities or number of activities completed requiring each skill.

The coefficients for various features may suggest the learning activities that lead to improved outcomes and suggest how content items can be ranked. The greater the coefficient, the greater its influence on success. Before the training phase, the coefficient can be preset. During the training phase, the weight of each coefficient is continuously updated. For example, after the system receives input (such as the learner's hours of study per week, history of interaction with learning activities, scores on learning activities, participation in group activities, etc.) the system can infer whether the learner will be able to successfully complete any given learning activity. The model can also suggest what factors have contributed to the learner's success (factors with greater weight).

In a exemplary embodiment of the invention, the system employs a collaborative filtering model. The model may be based on the question: for a person who has viewed a set of items and possibly has other properties, what would a ‘similar person’ want to look at next? This can be represented as matrix decomposition such as Singular Value Decomposition, or with a probabilistic interpretation, such as either probabilistic latent semantic analysis (plsa) or latent dirichlet allocation (lda), which will suggest how content items can be ranked. The system finds topic distribution among documents and words (users and activities). These topics are internal but can have external meaning, grouping the interests of learners. The system identifies top activities not yet viewed by the learner from a list ranking topics for that learner. The list of top topics represent learner interests based on activities the learner has already chosen. Top activities on a given topic are activities usually chosen by the people interested in the topic.

In an exemplary embodiment of the invention, click ranking is used to rank content or training modalities. When presenting a learner with multiple alternatives, the learner will look among them, choosing for each one whether or not to investigate the item in more detail, and then decide whether or not to move on to another. This reveals information about which items are truly useful and suggests how content items can be ranked. Click ranking can be used to infer the relevance of content vs. attributes used to process the query. Therefore, click ranking also can be used to find user preferences.

In an exemplary embodiment of the invention, a High Performer Preference model is developed. The system segments individual activity into two factors: time spent engaging in each learning activity and average skill increase per scored activity. Using these factors, a regression model is used to estimate how long it will take the learner to achieve a specific skill increase on a scored activity. The system splits individual activity via time frames (e.g. 2 weeks), and then, from these time frames, the system builds aregression model input vector. Each cell in the vector is a period of time, or can indicate time spent on a particular activity the learner has completed during the time period. As a dependent variable, the system uses skill increase; therefore, after training, the system can calculate how individual activities affect skill increase. This model is then used to suggest how content items can be ranked based on which content items tend to increase skills in the least amount of time.

### BRIEF DESCRIPTION OF THE DRAWINGS

Exemplary embodiments of the invention can be understood in more detail from the following descriptions taken in conjunction with the accompanying drawings in which:

FIG. 1 illustrates a system configured to provide an artificial intelligence based recommendation engine to provide tailored curricula to users, according to an exemplary embodiment of the invention.

FIG. 2 illustrates exemplary tables that can be used by the system to determine content to recommend.

FIG. 3 illustrates exemplary modalities supported by the system.

FIG. 4 illustrates a method of providing learning according to an exemplary embodiment of the invention.

FIG. 5 illustrates the system according to an exemplary embodiment of the invention.

FIG. 6 illustrates a dashboard tool of the system of FIG. 5 according to an exemplary embodiment of the invention.

FIG. 7 illustrates a user interventions tool of the system of FIG. 5 according to an exemplary embodiment of the invention.

FIG. 8 illustrates a web-based administration tool of the system of FIG. 5 according to an exemplary embodiment of the invention.

FIG. 9 illustrates a server tool of the system of FIG. 5 according to an exemplary embodiment of the invention.

FIG. 10 illustrates a lens tool of the system of FIG. 5 according to an exemplary embodiment of the invention.

FIG. 11 illustrates an administrator tool of the system of FIG. 5 according to an exemplary embodiment of the invention.

FIG. 12 illustrates a tracker tool of the system of FIG. 5 according to an exemplary embodiment of the invention.

FIG. 13 illustrates a process performed by a recipe tool of the system of FIG. 5 according to an exemplary embodiment of the invention.

FIG. 14 illustrates a dashboard tool of a user interface of the system of FIG. 5 according to an exemplary embodiment of the invention.

FIG. 15 illustrates an advisor tool of the user interface of the system of FIG. 5 according to an exemplary embodiment of the invention.

FIG. 16 illustrates a catalog of the user interface of the system of FIG. 5 according to an exemplary embodiment of the invention.

FIG. 17 illustrates a process using a recipe of the recipe tool to determine activities to recommend according to an exemplary embodiment of the invention.

FIG. 18 illustrates an exemplary plot of the probability of a given person with a given proficiency to answer a question correctly against proficiency.

FIG. 19 illustrates exemplary curves that may be used to determine question certainty.

FIG. 20 illustrates an exemplary curve depicting the probability of getting a correct response verses the ability of a user.

FIG. 21 illustrates an exemplary Bayesian Posterior.

FIG. 22 illustrates a method of determining the most likely value of a user's skill according to an exemplary embodiment of the invention and choosing the next question which will convey the maximum information.

FIG. 23 illustrates an example of a computer system capable of implementing methods and systems according to embodiments of the present invention.

### DETAILED DESCRIPTION

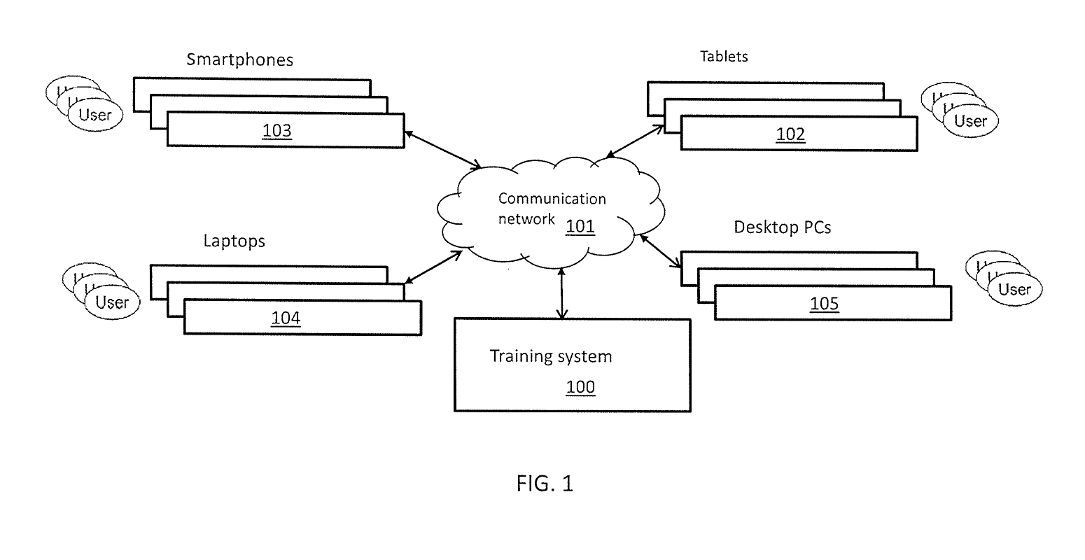

According to an exemplary embodiment, a system provides an artificial intelligence (AI) based recommendation engine (hereinafter referred to as the “Brain”) which advises a learner on learning activities, resources & communities. An exemplary embodiment of the system is illustrated in FIG. 1. The system includes a learning system 100 (e.g., a computer) that houses the Brain, and which is connected to one or more users across a communication network 101 (e.g., the Internet). As shown in FIG. 1, the users may connect to the learning system using tablet computers 102 (e.g., an IPAD), smart phones 103, laptop computers 104, desktop personal computers 105. Additional portable devices not shown in FIG. 1 may also interface with the learning system 100.

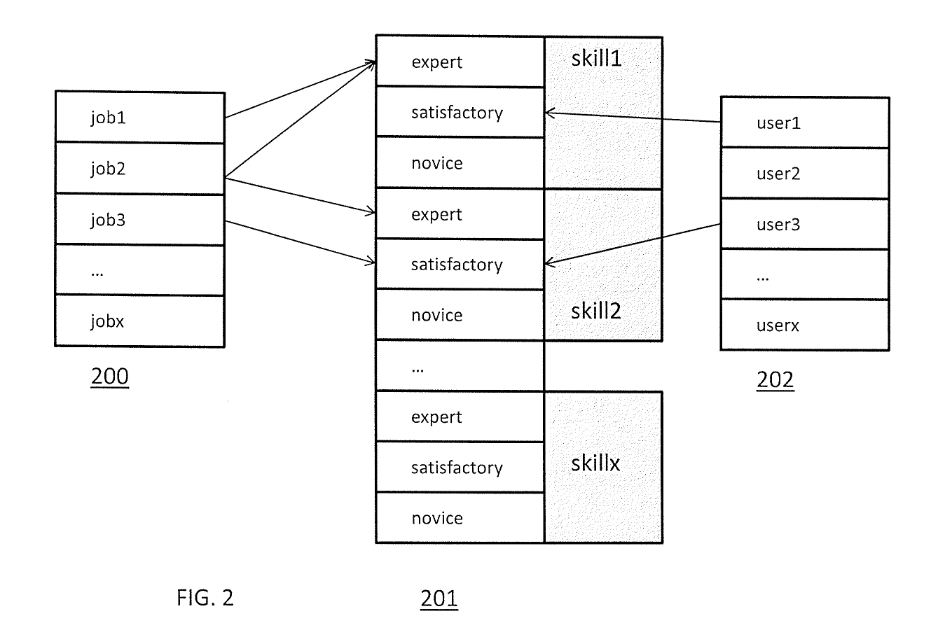

To assist the Brain, the learning system provides mechanisms to define, edit, and organize a hierarchical list of skills including a definition of proficiency levels for each skill, a hierarchical list of roles, a mapping of skills required for each role, a list of possible goals (e.g., obtaining a new role with higher skills required within a given time period, obtaining a certain mastery of a skill, etc.). FIG. 2 illustrates an example of tables that may be stored by the learning system that shows a mapping of roles to skills and users to skills. The role table 200 includes an entry for each role, the skills table 201 includes an entry for each skill, which is subdivided into different levels of proficiency, and the user table 202 includes an entry for each user. The roles table 200 is linked to the skills table 201 to indicate what skills are required for each role. As shown in FIG. 2, the first role (role1) requires only expert knowledge in the first skill (skill1), the second role (role2) requires expert knowledge in the first skill (skill1) and expert knowledge in the second skill (skill2), and the third role (role3) requires only satisfactory knowledge in the second skill. The user table 202 is linked to the skills table 201 to indicate what skills each user currently has. As shown in FIG. 2, the first user (user1) has satisfactory knowledge in the first skill, the second user (user2) has no knowledge of the first and second skills (i.e., these are skill gaps), and the third user (user3) has satisfactory knowledge of the second skill. Thus, if it is the first user's goal to obtain the first role, from reviewing the tables, the Brain knows that the first user needs to increase their knowledge of the first skill from a satisfactory level to an expert level, and structures their learning content accordingly. Please note, while FIG. 2 shows only three different levels of mastery, a fewer or greater number of levels of mastery are supported.

The system may also represent the relationship between skills in graph representation or in a hierarchical representation in a relational database. A self joining table of skills, a table of people, and a many to many table that lists skill person pairs may be present. Then, if one queries for a user, they would his current value for each skill. In a non-Bayesian technique, skill levels are constant integer or floating point values. In a Bayesian technique, each skill is represented by continuous probability curve. The curve can be approximated using a set number of values (e.g., 100). The local maxima can be solved for by taking a weight average.

The Brain takes a particular goal of user (e.g., obtain a new role with a different skill set than that which is currently held by the user) and maps it to a set of recommended content. For example, an entry of the user table 202 may include a list of goals of the user (e.g., obtain role1).

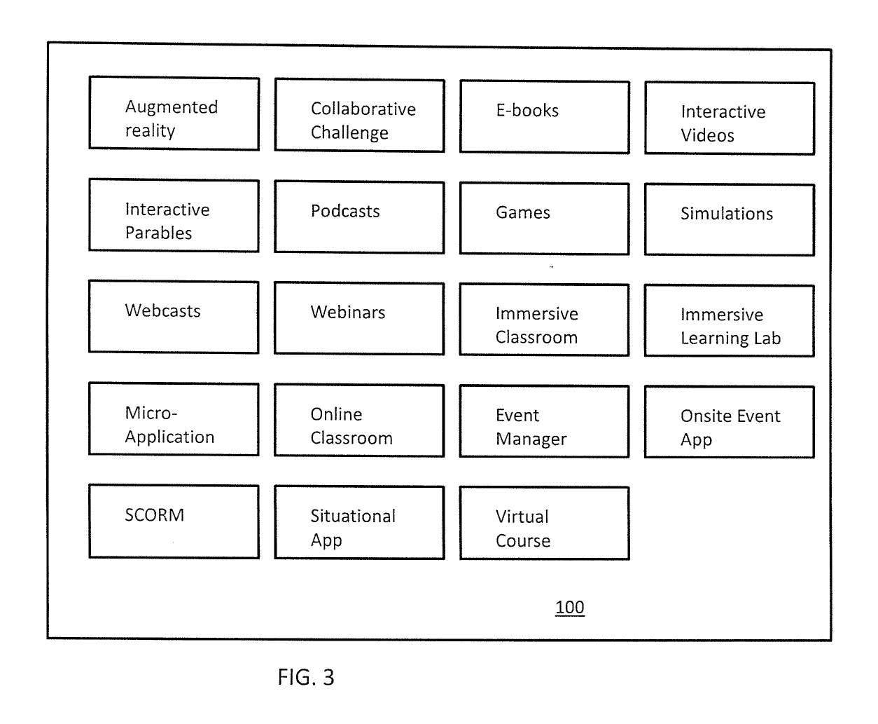

The recommended content exists in multiple formats. For example, as shown in FIG. 3, the system provides various learning formats such as augmented reality, collaborative challenges, electronic books (eBooks), interactive videos, interactive parables, podcasts, games, simulations, webcasts, webinars, and many more modalities. The learning modalities will be described in more detail below. Further, the system is not limited to the above-listed or illustrated modalities.

The system has a sufficiently large content pool so that a given query by a user for content (e.g., learning content) will result in multiple matches. The Brain can then filter the resulting set of content to match the search criteria. The AI can then assign a ranking to each match based on how good of a match the content is considered for that user. For example, if first content and second content addressing a skill requisite for a goal position are returned, and the Brain determines that the first content is more likely to increase the learner's skill than the second content, the Brain will rank the first content higher than the second content.

The ranking score may be arrived at using a customizable parametric equation (e.g., of the form ax+by, where x and y are context variables of interest and ‘a’ and ‘b’ are coefficients or weights). These equations (e.g., also referred to as recipes) may be defined by an administrator (e.g., a web-based administrator) using a visual editor. The administrator is given a choice of both the context variables used and the coefficients. In this way, an administrator can decide which factors are used in ranking content and their relative weightings. The resulting set of matches is sorted based on the rankings so that the best matches are presented first.

Examples of context variables that may be used in a recipe include modality type (e.g., interactive video, podcast, E-book, etc.) and content difficulty.

Another example of a context variable that may be used in a recipe to rank content is personal stated preference for modality type. For example, if the learner prefers e-books over interactive videos, the e-books could receive a higher weight.

Another example of a context variable that may be used in a recipe to rank content is a correlation between modality type and skill improvement. For example, if a user learns better from e-books than interactive videos, e-books can be ranked higher than interactive videos.

Another example of a context variable that may be used in a recipe to rank content is a time constraint. For example, if a user only has 1 hour available, content that can be observed within that time limit could receive a higher weight.

Another example of a content variable that may be used in a recipe to rank content is peer/manager recommendation. For example, content with a high rating from a peer could be given a higher weight than content that received a lower rating or no rating.

Another example of a context variable that may be used in a recipe to rank content is organization/administrator requirements. For example, if an administrator requires that a user be trained on a particular piece of content, it could receive a higher weight than other non-required content.

Another example of a content variable that may be used in a recipe to rank content is skills related to goal role/current role. For example, content that teaches skills requisite to a particular goal role could be ranked higher than content that teaches skills unrelated to the goal role.

Another example of a content variable that may be used in a recipe to rank content is skills identified by a computer analysis that match largest skill gaps. For example, if the user has some small gap in a first skill for a role, but a large gap for a second skill in the role, content that teaches the second skill can be given a higher weight than content that teaches the first skill. For example, referring to FIG. 2, if the first user wants to obtain role2, he has a small gap in the expert level required for skill1 of the role2 since he has a satisfactory knowledge level of skill1, but has a large gap in his knowledge of skill2 since it requires an expert level. Thus, the system could give or recommend to the user more learning content related to skill2.

Another example of a content variable that may be used in a recipe to rank content is modalities that work well in sequence with other modalities. For example, if it is determined that users perform better when learning begins with a simulation and follows with an E-book, this particular sequence could receive a higher weight than other learning sequences, so that the corresponding learning sequence is recommended over learning sequences with lower weights.

In an exemplary embodiment, the system is configured to automatically determine, for each user of the system, an optimal set of learning modalities for the corresponding user. The system is configured to consider context information (e.g., see the above context variables) in its determination.

As discussed above, the context information may include at least one modality preference of the user provided by the user. In an exemplary embodiment, the system provides a graphical user interface (GUI) that enables a user to select their favorite learning modalities. The GUI may also enable the user to rank their favorite learning modalities. For example, if the user ranks podcasts higher than e-books, the system can design a learning schedule for the user that provides a higher percentage of podcasts than e-books (e.g., 70% podcasts: 30% e-books, etc.).

In an exemplary embodiment, the Brain determines the optimal set of learning modalities for a user by considering context information such as the performance of the user and other users in the available learning modalities. The performance may be stored in history data that was previously saved by the system in an internal database, or an external source of data, which the system can access.

In an exemplary embodiment, the Brain determines the optimal set of learning modalities by comparing the performance of the user in each learning modality against a predefined threshold, and selecting those that exceed the threshold. For example, if the threshold is 70% and the performance of the user on learning content in interactive videos, audio podcasts, and e-books is 80%, 50%, 85%, respectively, the system would decide that the user's optimal set includes interactive videos and E-books.

In another embodiment, the Brain chooses a predetermined number of learning modalities where the user performs best as his optimal set of learning modalities. For example, if the predetermined number is 2, the scores of the user on each learning modality can be ordered from smallest to largest, and then the learning modalities with the highest two scores can be chosen as the user's optimal set of learning modalities.

The Brain may also structure the curricula to have more learning in the modalities the user performed better in. For example, if the optimal set for the user is interactive videos and E-books, but the user performed better on interactive videos than E-books, the system could design a learning schedule for the user that provides a higher percentage of interactive videos than E-books (e.g., 70% interactive videos:30% e-books).

In an exemplary embodiment, the Brain infers an overall type of learning that the user is most likely to learn best from (e.g., audio learner, visual learner). In an exemplary embodiment, each learning modality is assigned metadata (e.g., “primarily audio”, “primarily visual”, etc.). For example, if the user performs better in learning modalities that are primarily audio than in learning modalities that are primarily visual, the system can infer that the learning should include primarily audio learning and select learning content having the “primarily audio” metadata. Thus, even though the Brain only has performance data of the user in a first audio modality, the Brian can tailor the learning to include additional sources of audio learning (e.g., a second audio modality).

Since the user's performance on different learning modalities may change over time, the system can periodically recalculate the best learning mix for each user. For example, even though the user was previously performing better on E-book based learning than on interactive video based learning, and was previously receiving more E-book based learning, if the user later begins to perform better on the interactive videos, the Brain can reconfigure the user's learning to include more videos or less E-books.

In an exemplary embodiment, the Brain uses a cluster analysis to look for groupings of modalities where a group of users show a greater than average rate of improvement in a skill over a time period where the users focus primarily on activities in that cluster. For example, if a group of users show a greater rate of improvement in mathematical aptitude when being trained using interactive simulations and E-books, even though one of the group individually learned better with podcast based learning, the Brain would determine that the optimal learning set for the group is interactive simulations and E-books. The Brain can then provide learning that has been tailored for the group to a new individual that has characteristics of the group.

In an exemplary embodiment, the learning can be tailored based on context information that includes calendar data, location data, and contact data.

The calendar data may come from a calendar program such as Microsoft Outlook or Google Calendar. However, the invention is not limited to any particular calendar program. The calendar data may include future user events (e.g., a meeting), the participants of those events, the locations of the events, the date/times of the events, the topic of the events (discuss topicX, discuss productY), etc.

The location data may include the current geographic location of the user, which could be determined by location-based services of a device on which the user accesses the system/Brain. For example, if the user accesses the system using a tablet computer, its onboard GPS could be accessed to determine the present location of the user.

The contact data may come from a contact program such as Microsoft Outlook, or Google Contacts. However, the invention is not limited to any particular contact program. The contact data may indicate the location (e.g., address, lat/long) of the contact, and other personal information of the contact (e.g., profession, preferences).

In an exemplary embodiment, the Brain determines the user will be engaging in a meeting with a particular contact by analyzing events in the user's calendar program and data in the user's contact program, determines context information for the contact using the contact program and any other available data sources on the contact, and generates a learning schedule for the user based on context information about the contact. For example, if contact program includes information about a contact (e.g., profession, interests, affiliations, etc.) the Brain might provide learning content on those subjects.

For example, if the system determines from the user's calendar and contact programs that the user's next appointment is a meeting on a particular topic, the system can provide learning to the user on that specific topic.

If the events in the user's calendar are not very detailed, or no event information is available, the system might infer that a meeting is about to take place and the identity of meeting participants by comparing the present location of the user with the location of the user's contacts. For example, if the present location of the user is within a predetermined distance of one of the user's contacts, it might be inferred that a meeting between the user and the matching contact is about to take place. The system can then provide learning to the user based on context information of the matching contact. The context information of the contact may be stored in the contact program of the user or stored in a separately accessible database. For example, the user could have previously entered context information within the contact program such as contact affiliations and interests.

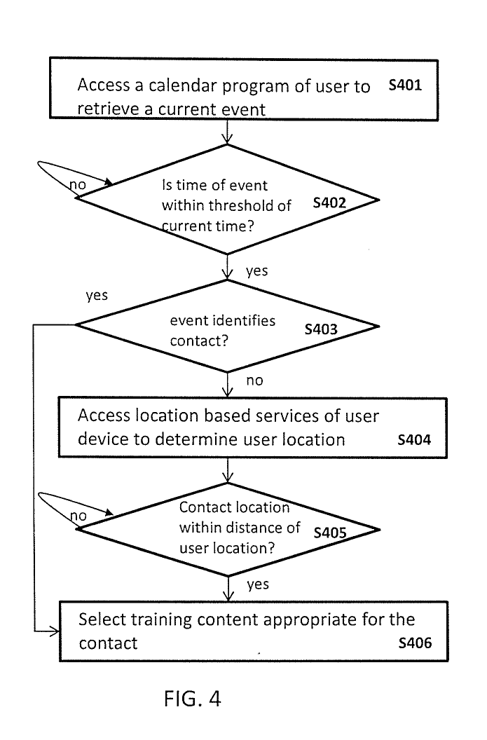

FIG. 4 is a flowchart that shows a method of providing learning according to an exemplary embodiment of the invention. Referring to FIG. 4, the method includes: accessing a calendar program of a user to retrieve a current event (S401) and determining whether the time of the event is within predefined threshold of the current time (S402). If the time of the event is within the threshold, the method determines whether the event identifies a contact (S403). If the event does not identity a contact, the method accesses location based services of the user's device (e.g., smartphone, tablet, etc.) to determine the location of the user (S404). The method then accesses a contact program of the user to determine whether a contact is within a predefined distance of the location of the user (S405). If the contact location is within the predefined distance, the method selects learning content appropriate to the contact (S406). For example, the method may select appropriate learning content based on data stored about the contact in a contact program (e.g., contact program indicates the contact's location and interests) and/or data stored about the event in the calendar program (e.g., meeting to discuss a particular topic), and or data stored about the user (e.g., user's profession, interests and affiliations). If the method is able to identify a contact the user is about to meet with, the method selects learning content appropriate for the contact (S406).

As discussed above, the system can determine the location of the user's contacts by accessing the user's contact program (e.g., Google Contacts). It is assumed that least a portion of the system (e.g., a client program) is running in a mobile device carried by the user, and thus the location of the user can be determined by accessing the location based services of that mobile device. However, the system may use other internal or external data sources to determine the location of the user and the location of the user's contacts.

The system may be configured to deliver learning by predicting questions a contact might ask based on multiple internal and external data sources. For example, if context information about the contact is present in a CRM (Customer Relationship Management) database that indicates the contact may be interested in one or more products or services provided by the user's company, the user's learning can be tailored to include educational content on those products or services.

In an exemplary embodiment, the system is configured to adapt learning content recommendations for a user based on the amount of time the user is able to spend on learning. For example, without considering time, the system could generate a learning schedule for an individual that takes 1 hour. However, if the user only has, for example, 30 minutes of available study time, the system is configured to adjust the learning schedule by omitting certain content or shortening other content, so that learning is optimal and fits within the user's time parameters. The system is configured to perform this adjustment based on a parametric equation previously entered by an administrator. For example, the equation could indicate that a first skill should have twice the weight of a second skill when time constraints are imposed. For example, if the learning schedule originally had 30 minutes of learning content on each skill, the system could adjust the learning schedule to have 20 minutes of learning content on the first skill and only 10 minutes of learning content on the second skill. For example, prior to presenting the learning content to the user, the system can provide a graphical user interface to the user that informs the user of the estimated amount of time needed to complete the learning and enables the user to enter an amount of time available so the system knows how to restructure the learning content presented.

When the Brain returns a content recommendation set, instead of returning the actual content types and modalities, it can return metadata tags, which are then mapped to the available content pool.

The system contains a large library of content. Content items can either be specific to a modality such as an E-Book or usable across modalities such as a JPEG image. The system is configured to maintain metadata for all content. For example, the metadata may include a primary category that indicates the kind of learning performed, a keyword, a difficulty level for the content, a master level required (e.g., satisfactory proficiency required for understanding), a modality type (e.g., E-book or interactive video), and other data specific to content type (e.g., page length of E-book, duration of podcast, average time to complete a simulation, etc.).

As discussed above, the Brain can consider requirements when deciding what content to recommend to a user. A requirement can be mandatory and take the form of a requirement to complete a specific activity (e.g., provide learning on particular content) or to complete a single or set of activities that meets a criteria (e.g., provide learning on a certain topic which has a certain required level of mastery). Requirements may have a time component and may be targeted to an individual or a group.

The system is configured to enable individuals (e.g., managers, trainers, coaches, peers, users) to recommend an activity to an individual or a group, where all recommendations are persistently stored.

The system is configured to maintain for each user a list of goals. Examples of these goals includes: meeting company wide requirements, meeting requirements of a particular role, meeting a manager's goals set or another's individual's goals set, and meeting the goal requirements that the learner has established for themselves. The Brain considers these goals and the skills required for each goal role when recommending content to the user. A goal may also be time sensitive and user defined. For example, the system is configured to enable a user to create a new goal and set up time constraints on that goal (e.g., become a sales manager in 6 months). The system can then optimize the learning schedule and curriculum of the user so they can achieve their goal in the required time. For example, if several different types of learning content are available that assist users in advancing to meet a goal, the system could suggest the one that fits within the user's time constraints, even if another is more optimal for learning. Another example of a user-defined goal is to gain mastery in a given competency (e.g., to become an expert in a given skill). A goal can also be defined on the fly and relate to time or location based constraints. For example, the goal could indicate that learning is to be completed within a particular time constraint, or learning is to be adjusted based on the user's present location.

The system maintains a model that normalizes the learner's modality scores. The system will score all modalities and normalize to the same scale, so the learner's scores on different content modalities are comparable. The system will then compute a Bayesian estimate by additionally considering the learner's normalized movement scores from skill to skill, and this will provide a network profile for each individual, reflecting strengths and weaknesses as well as offering a pathway to realize goals and acquire new roles. In an exemplary embodiment, the system uses a scale with a range of 1-1000. The upper and lower limit of the range may be changed in alternate embodiments. Once the scores for a modality are on this scale we can use a simple parametric equation (ax+by+cx)/n, where x, y and z are the normalized scores, a, b, and c are scaling factors, and n is the number of modalities. In the case where all modalities are considered to have equal importance, a, b, and c are set to one and the equation simply becomes an average. The normalization involves generating a mapping function to convert a score on an arbitrary scale to a scale of 1-1000. This can be a simple linear scaling (i.e. Scores on a scale of 1-4000 are simple divided by 4) or any complex equation that yield an output of between 1 and 1000.

The system can predict an optimal learning plan by computing a matrix of expressions for velocity for the acquisition for each skill associated with each activity One dimension of the matrix represents skills while the other contains the velocity of skill acquisition measured in estimated points gained per hours of study. The system can therefore compare different learning plans and minimize total predicted time towards mastery of a given skill. This is possible as each skill is measured on a normalized scale and the system maintains a separate Bayesian prior distribution function or discretized array of values approximating the function, to describe each skill value. Velocity and acceleration of skill acquisition can be calculated by the first and second derivative of the historical skill values with respect to time. The matrices will be dependent on factors such as the order of learning or other parameters such as time of day. The functions modifying the velocities will be based on a Bayesian model comparison of the various measurable factors from the systems tracking of historical data. A subset of the most predictive models will be used to compare different paths through different combination of learning material. The optimal path/suggestion of learning materials is then calculated with path optimization algorithms that could include but are not limited to Brute force (for small sets), Branch and Bound Algorithms and Nearest Neighbor Search.

An activity such as a SIM can be represented by a Finite State Machine. From any given state the users can move to other states based on the rules of the simulation. A value can be assigned to each state transition. The history of state transitions can be scored by summing the state scores. This is an example of a movement score. For a disallow driven Sim, the user is presented a series of choices which are implemented as characters talking to one another. Each time a choice is made, the Sim keeps track of the state. One example is keeping track of the number of times the learner talked to a particular character. The learner's dialog choices would vary based on the path taken by the learner within the Sim.

The system performs a Bayesian analysis of behavior within a modality (e.g. the movement in a learner's scores when the learner completes multiple E-Books sequentially) and movement between modalities (e.g. the movement in the learner's scores when the learner completes an E-Books and an interactive video sequentially), and then offers a recipe whereby each learner makes their next learning activity selection based on an updated analysis of previous outcomes, especially the learner's successes and failures within the last modality. For example, if a learner's scores are consistently positively affected by completing an E-Book and then a Simulation, the recipe will suggest Simulation content whenever the learner completes an E-Book.

In an exemplary embodiment of the invention, the system provides learning using games, and uses fuzzy logic to define state transitions in the games. Fuzzy logic produces final state scores from second generation decision trees and fuzzy logic rules move the player through the decision trees with scores inputted into Bayesian analysis for next suggested simulation or modality. One such example would be a Simulation where the learner plays a salesperson who needs to get past a receptionist to see the buyer of a product. Interacting with the receptionist would represent one state and interacting with the buyer might represent another. To make the sim effective, the rules governing getting past the receptionist must not be trivial and at the same time they must be encodable by a non-technical Subject Matter Expert. Using a fuzzy rule set and editor, the rules could take the form of ambiguous English language constructs such as:“If the reception is in a very good mood and you are polite to her, she will probably let you through.”

In an exemplary embodiment, the system provides learning in the form of a game played by multiple users playing together, where the users are split into different teams. The system can maintain a player ability score, a player engagement score, and player affinity scores for pairs of players. The player ability score indicates the ability of the player in the game. The player engagement score indicates how often the player has played the game. Each affinity score indicates how similar two players are. The affinity scores are used to determine how players are assigned to teams. For example, each user can be asked N survey questions that relate to team preferences where each player chooses 1-5 for each question, 1 being least preferred and 5 being most preferred, to produce the affinity score of Equation 1 as follows:

$$AffinityScore = \frac{1}{Δ Q 1} + \frac{1}{Δ Q 2} + … + \frac{1}{Δ QN} \qquad [ Equation 1 ]$$

The value ΔQ is the difference in the 1-5 score answered for a given question among two players. The value ΔQ may be normalized so that it is not 0. For example, if player 1 and player 2 each answer a given question the same (e.g., all 5s), the ΔQ would be 0, but can be adjusted from 0 to 1, and if 12 questions were present, the affinity score between players 1 and 2 would be 12. For example, if player 3 then answers all the questions with a 1, the affinity score between player 3 and player 1 without the above adjustment is 3 (e.g., ¼*12=3). Thus, the system could decide to put players 1 and 2 on the same team since their affinity score is higher than the affinity score between player 1 and player 3.

In an exemplary embodiment of the invention, the system determines how to segregate users into two different teams for a game using a graph analysis and the affinity scores. The graph is basically a group of circles with lines connecting them. Each line represents some interaction a learner has had with the system. Each action carries a different weight. The graph includes player nodes and each edge between player nodes stores an affinity score resulting from a previous affinity score equation. “Traversing edges” means moving along the edges and summing the score. After determining the size of the teams appropriate for the upcoming game, the player nodes are filtered to the appropriate player pool from which to form teams. The system then duplicates the resulting graph and traverses it by moving along edges with the highest affinity score, forming teams out of players it traverses to in sequential order and subsequently deleting player nodes it leaves.

For example, to create 2 teams using a graph of 30 people, the system will explicitly calculate the affinity score between all pairs of people, or, if the number is too great, the system can use any number of clustering algorithms. A team is filled when the requisite number of people has been placed on it.

In an exemplary embodiment of the invention, the system provides learning using simulations. The system can determine which simulation to run for a given user by leveraging collaborative filtering to get a measure of a simulation's popularity amongst the player base. For example, if a particular simulation is popular with a given group and the user has characteristics of that group, the simulation will be recommended to the user. For example, when deciding whether to select one simulation for a given user among many that are available, the system can look at a pre-defined number of players in terms of their Affinity Score with the user and choose the simulation associated with the players with the highest total player engagement score. For example, assuming the players with a highest affinity score with respect to user number 5, if their player engagement scores for a first simulation are 0, 1, 0, 2, 1, respectively, a total player engagement score for the first simulation is 4, if their player engagement scores for a second simulation are 0, 1, 1, 2, 1, respectively, a total player engagement score for the second simulation is 5, and thus the second simulation would be recommended to the user.

A computer adaptive testing (CAT) question selection can be used to recommend individual scenarios in a simulation. Using item response theory, the set of scenarios within a simulation is ordered by decreasing Probability for Correct Response Pᵢⱼ for the specific player engaged in the Simulation, and may be calculated according to equation 1, where i is the scenario, j is the user, a is the discrimination parameter (how good the question is at measuring a skill,) b is difficulty, and c is a guessing parameter.

$${P}_{ij} ( {θ}_{j} , {a}_{i} , {b}_{i} , {c}_{i} ) = c + ( 1 - c ) \frac{{e}^{a ( θ - b )}}{1 + {e}^{a ( θ - b )}} \qquad Equation 1$$

A handful of scenarios from this set are presented to the player to guide choice behavior. When a player engages with a chosen scenario, they either get the answer correct or incorrect. The specific player's Ability Score increases or decreases by 0.3*(1−Probability for Correct Response) for the specific scenario they engaged with if they answered correctly or incorrectly, respectively. The number 0.3 is a sample weighting factor. Other numbers could be used, but in the content of the equation they fall into a range of 0-1, as it is a normalized weighting factor.

A simulation may include one or more virtual characters, where dialog between characters is represented in a tree structure. Each node of the tree represents a dialog option with the child nodes representing possible responses. However, a tree with just 2 or three choices grows exponentially large and therefore unmanageable after a small depth. Therefore, child nodes can be hidden/turned off as the result of executing a series of rules. These rules can take a standard Boolean form or could be expressed as a fuzzy rule set.

The system can maintain a state machine for a simulation where the high level states represent simulated environments. A Simulation might for example contain a state/scene in a parking lot, an elevator, a lobby and an office. Each state may contain an embedded state machine and this hierarchy can continue multiple levels deep. This allows for multiple representations of a given context. A situation can be represented as a set of distinct states or as nested series of sub states. In a state machine, permissible transitions are represented by arrows. One state may be connected to one or more additional states. For example there may be an arrow connecting the lobby state to the office state and an arrow from the office to the lobby. The system supports a few mechanisms to define possible state transitions such as execution of a fuzzy rule set, the end state of the traversal of a dialog tree, and interaction with the environment.

A rules editor can be used to create a series of fuzzy rules. The author can then apply a subset of the rules to a given state and configure triggers to evaluate the rules. The triggers may include time based triggers such as every minute and action based triggers such as a state transition or specific interaction with the environment.

The system contains an embedded test engine, which can be used to determine user proficiency in a given one or more skills. The test engine is capable of delivering individual questions and exams using either a linear or Computer Adaptive format (CAT). CAT testing is based on varying the difficulty of questions based on Question Selection Theory. In a CAT, you do not have a set list of questions. At any time a user may get rated on a number of skills. Traditionally CAT testing requires very large question pools of calibrated questions. The system will primarily use smaller pools of questions assumed to fit an ideal model with the questions' authors assigning difficulty based on their instructional experience.

An ideal model is created by developing a large question pool and asking learners the questions in a non-scoring context. Any question where the probability curve from the result matched that predicted by Question Selection Theory is retained and asked later in a scoring context. Question that do not match will be discarded. In a smaller pool, we either offer fewer question to choose from, in which case the ability of each question to discriminate is lower, or we do not pretest the question. In this case, questions are scored based on expert opinion of the assessment author or on how close a question's response curve matches the theoretical curve.

The test engine can be configured to ask the user questions that directly relate to the learning provided by the optimal set of learning modalities determined above. For example, if the learning content is designed to improve the user's leadership skills, and the learning content listed typical actions performed by a leader in response to a given situation, the questions could ask the user to name the actions directly mentioned in the learning content for each corresponding problem. However, rather than performing such direct testing, in an exemplary embodiment, the test engine is configured to measure the skills of a user in an indirect fashion.

In an exemplary embodiment, the test engine is configured to measure a user's ability to deal with ambiguous instructions by presenting the learner with ambiguous instructions for an activity and evaluating how the learner responds. For example, if the learner tries to use a provided help function or chat function to get more feedback about the ambiguous instructions, the learner could be evaluated as responding well to ambiguous instructions, and if the user exits or moves onto the next instruction too quickly, the learner could be evaluated as responding poorly to ambiguous instructions. Responding well to ambiguity may be an indication that an individual has a determined personality (e.g., does not give up easily), whereas responding poorly could be an indication that an individual gives up too easily (e.g., more likely to fail in times of adversity).

In an exemplary embodiment, the test engine is configured to measure a user's integrity by asking the user to self-report time spent in each learning activity and determining whether the user has actually spent the reported time by accessing internal sensor data of the mobile device. For example, if other programs on the device (e.g., a chat program) are being accessed during the learning activity, the amount of time spent on these activities can be subtracted from the elapsed time of the learning activity and compared against the self-report time. In another example, the system accesses the accelerometer of the device to determine whether the device is idle for a period of time, and subtracts the idle time from the elapsed time of the learning activity for comparison against the self-report time.

The test engine is configured to evaluate the performance of a user who is tested. For example, if each test is a measure of a different skill, a higher performance in a given test equates to a higher performance in a given skill. However, instead of simply looking at a learner's absolute competence in a given skill, the test engine is also configured to determine the learner's rate of skill acquisition (e.g., 1^{st} derivative) and the acceleration of that skill acquisition (e.g., 2^{nd} derivative).

The system can examine a time-stamped history of tests results of the user on a given skill to determine the rate of skill acquisition and the acceleration of skill acquisition. In a rate of skill acquisition example, if a first user achieves a performance of 70% on a skill based on a first test result at time 0 and achieves a performance of 80% on the skill based on a second test result at time 1 hour, the first user has improved this skill 10% per hour; and if a second user achieves a performance of 50% on a skill based on a first test result at time 0 and achieves a performance of 80% on the skill based on a second test result at time 1 hour, the second user has improved this skill at 30% per hour (e.g., at a higher rate). In an acceleration of skill acquisition example, if the first user achieves a performance of 100% on the skill based on a third test result at time 2 hours, the current rate of improvement of the skill is 20% per hour, and the acceleration is 10% per hour squared (e.g., 20%/h−10%/h/one hour time difference=10% per hour squared).

The system can be configured to score a user's performance based on the amount of time taken to complete activities and the paths they take. For example, in a required E-Book, a user can be scored by time taken to visit each page, and in a modality where links to additional material are provided, a user may be scored on the frequency of participation in the related activities.

The system can use completion of certain goals or missions within a game or simulation to determine competency of the user in skill being tested by the game or simulation. For example, a user in a Sim focusing on research skills might gain or lose points depending on whether they check a secondary source for a critical piece of information. In another example, a user may be given the choice in a Sim to delegate some of their responsibilities to a colleague, and this may be counted for or against leadership skills, depending on the context.

The system can measure a user's leadership skills by examining the user's link sharing frequency and how many others follow the user's recommendations. Another measure of a user's leadership skills is the frequency and number of group activities the user is invited to join.

The frequency with which a manager or trainer requires or recommends an activity to a given user can be a measure of the user's competency in skills associated with that activity.

The test engine can test a user's decisiveness by measuring the average pause the user takes before making choices. For example, the longer the average pause, the less decisive the user might be, which could also lower the user's leadership score.

The test engine can measure a user's integrity based on the user's attempts to game the system by examining behaviors meant to bypass the intended use of the system. For example, an attempt to minimize a learning window so that a non-learning activity can be launched could indicate a lack of integrity.

The test engine can measure the competency of an individual by combining an internally generated competency score generated from performances on internal tests, simulations, and games, with a competency derived from external data. For example, if the user was tested for his competency as a salesman and received a low score, external data indicating a higher than average volume of sales can be factored in to boost the user's score in this competency.

The system provides a mechanism for a manager to define a dynamic evaluation form. This form can be filled out by human influencers, rating an individual learner on a customized set of competencies. At least one of the available learning modalities supports a multiuser interaction lead by a human instructor, where the instructor is encouraged or required to fill out an evaluation of users engaged in the modality. The system has the ability to combine human and computer generated assessments. The system can also import evaluations generated by humans outside of the system, and has a mechanism for managers and trainers to author and fill out dynamic evaluation forms.

As discussed above, the system provides various learning modalities. The front end of the system consists of an application with over a dozen embedded media players (e.g., referred to as modalities). Each modality is optimized toward a different learning/teaching mechanism.

The modalities provided may include augmented reality, where delivery of intelligent data about people, artifacts, and geolocations, as well as virtual humans are displayed through a graphical user interface to enrich the learning experience. Virtual Humans are 3D AI-enabled characters that interact with users. People and physical objects may be represented by objects. The intelligent data includes statistical analyses, profiles and other information revealed upon augmented reality-enabled interactions with people and physical objects (e.g., artifacts). Geolocations are real geographic locations that have data assigned to them. The system may also maintain an object that represents a Quick Response Code (QRC), which is a matrix bar code with fast readability and large storage capacity. For example, users with a camera-equipped mobile devices and QRC reader application can scan the image of the QR Code to display text and graphical information, or open a web page in the device's browser.

The modalities may include a collaborative challenge, which is a group based persistent problem solving learning activity that can be implemented onsite, online, or using a synthetic environment.

The modalities may include an E-book, which is a book-length publication in digital form, consisting of text, images, and media objects.

The modalities may include an Immersive Classroom, which is a synchronous learning path taken by multiple learners that takes place in a virtual environment.

The modalities may include an Immersive Learning Lab, which is an asynchronous learning path taken by individual learner that takes place in a virtual environment.

The modalities may include an Interactive Parable, which is an instructional story telling that may contain interactive elements implemented in 2D animation.

The modalities may include an Interactive Video, which is a Cinematic learning activity where learners can interact with the media and influence content presentation and the learning path.

The modalities may include a Micro-Application, which is a mobile application deployed within or externally to the learning platform that transmits data to/from the system.

The modalities may include an Online Classroom, which is a video enabled interactive learning activity that takes place online in a synchronous mode that involves an instructor and multiple learners.

The modalities may include an Event Manager, which is an application that supports and enhances the onsite learning experience. The event manager may include functions such as Digital Registration, a Digital Session Check-In, a Paperless Meeting Information Delivery (e.g., Mapping, Scheduling, Meeting materials, Guides, Notifications), Session Tools (e.g., Audience Response System, Learning Assessment, Learner Generated Annotations, Secondary Screen, Assessments/Certifications), Break-out Session Management (e.g., providing tools for supporting onsite learning activities in break-out groups), Onsite Gaming Management (e.g., Facilitates, analyzes and reports onsite one-on-one and group competitions), and QR Codes.

The modalities may include an Onsite Event Application, which is a combination of an Event Manager and a Virtual Course.

The modalities may include Podcasts, which are digital media files (either audio or video) that are released episodically and downloaded through web syndication.

The modalities may include serious or casual games, which may be competitive or collaborative learning activities used for skill reinforcement that utilizes gamification models and methods. The games may include Single and Multi-player modes. In an exemplary embodiment, the games use the Unity 3D game engine. In head to head activities that yield a winner such as a 2 player serious game, the system can measure relative mastery by looking at win/loss records with consideration of the opponents in the same manner as done in tournament Chess (ELORatings).

The modalities may include sharable content object reference model (SCORM) media, which is a purchased or custom-built self-study online learning activity developed for learning management system (LMS) delivery.

The modalities may include various different kinds of simulations. The simulations may include a single Player Simulation, where a user plays against a computer (e.g., can be Hybrid and Immersive), a Multi-Player Simulation, where two users play head to head (e.g., can be Hybrid and Immersive), a Hybrid Blended Immersive Single Player Simulation, a Hybrid Blended Immersive Multi-Player Simulation, and an Immersive Learning Simulation, which combines simulation, instruction, and gamification techniques to create a truly engaging and behavior-changing form of learning.

The modalities may include a Situational Application, which is an evaporated, content-relevant application generated by AI and providing just-in-time cognitive scaffolding, with content and UI formulated based on (a) system analysis of the learner's decision-making paths and (b) goals set up by the user.

The modalities may include a Virtual Course, which is a series of interdependent learning objects (in multiple modalities) structured to enable an online learning experience; assembled by an instructor or manager from a content catalog for a group of learners with similar learning needs.

The modalities may include a Webcast or a Webinar. A Webcast is a media presentation distributed over the Internet using streaming media technology to distribute a single content source to many simultaneous listeners/viewers. A webcast may either be distributed live or on demand. A Webinar is an interactive learning activity that takes place online in a synchronous mode that involves one or more instructors and multiple learners.

A tracking mechanism of the system is configured to collect and manage tracking data for each user. The tracking mechanism may be embedded within the frontend application.

The tracking mechanism records Learner interaction at a very fine-grained level of detail. The below describes examples of items the tracking mechanism is capable of recording/tracking. However, the tracking mechanism is not limited to tracking the examples provided below.

The tracking mechanism can track each login of a user to the system and record the date and time the login occurred, the geolocation from which the user logged on, and the duration the user was logged on.

The tracking mechanism may also track the launch of each activity by the user and a detailed activity stream of interaction with the activity including such events as moving from page to page in an e-book, listening to a podcast, completing a level of a serious game, attending a webinar, etc.

The tracking mechanism may also maintain a detailed record of use of the tools including events such as bookmarking a page in an e-book, taking notes on a webcast, chatting with a peer/trainer/supervisor, obtaining help from an augmented reality avatar, etc.

The tracking mechanism may also track movement between modalities, use of the advisor, use of a frontend dashboard (e.g., a graphical user interface of the front end application used by a user to interface with the system), evaluation of browsed activities, etc.

For the augmented reality modality, the tracking mechanism can track interaction with a help Avatar, time/day modality was used, location modality was launched from, time spent in the modality, question asked by the user while in the modality, data displayed by the modality, use of QR codes, etc.

For the collaborative challenge modality, the tracking mechanism can track the time/day modality was used, location modality was launched from, time spent in the modality, the groups results of the challenge, the individual results, each decision point, data specific to the challenge, invitations to the challenge, times challengers arrived, etc.

For the E-book modality, the tracking mechanism can track time/day e-book was opened/closed, location from which user launched e-book, which pages were visited/read, how much time spent on each page, time spent interacting with videos, time spent interacting with animations, answer choices answered, time spent on each question, number of visits to each question, search terms entered, search results, which pages bookmarked, use of zoom, occurrences of content being shared, Highlight/markup of content, etc.

For the immersive classroom modality, the tracking mechanism can track each invitation, time users arrived to the classroom, location of each participant, time each user remained in classroom, text of chat, interaction with materials, whether each user completed, etc.

For the immersive classroom modality, the tracking mechanism can track time users arrived to the classroom, location of each participant, time each user remained in classroom, lab specific path and data, etc.

For the interactive parable modality, the tracking mechanism can track time/data modality was launched, location from which user launched modality, time spent on modality, pauses, plays, and seeks performed, etc.

For the interactive video modality, the tracking mechanism can track time/day modality was launched, location from which user launched modality, time spent on modality, pauses, plays, and seeks performed, following of a link, viewing of embedded/specific data, etc.

For the micro-application modality, the tracking mechanism can track time/date modality was launched, location from which user launched modality, etc.

For the onsite event modality, the tracking mechanism can track use of maps, scheduled viewed, edits to schedule, meeting materials viewed, interaction with guides, notifications (e.g., which were received, when were they acted on, when were they read, when were they dismissed, etc.), individual answers, etc.

For the podcast modality, the tracking mechanism can track time/date modality was launched, location from which user launched modality, play/pause of podcast, time spent in podcast, podcast information viewed, when podcast was completed, etc.

For the game modality, the tracking mechanism can track time/date game was launched, location from which user launched game, level reached, score, time spent in game, high score, specific game played, etc.

For the simulation modality, the tracking mechanism can track time/date sim was launched, location from which user launched sim, result of sim, path taken, time spent in sim, invitations, times parties arrived to sim, communications with Avatars, etc.

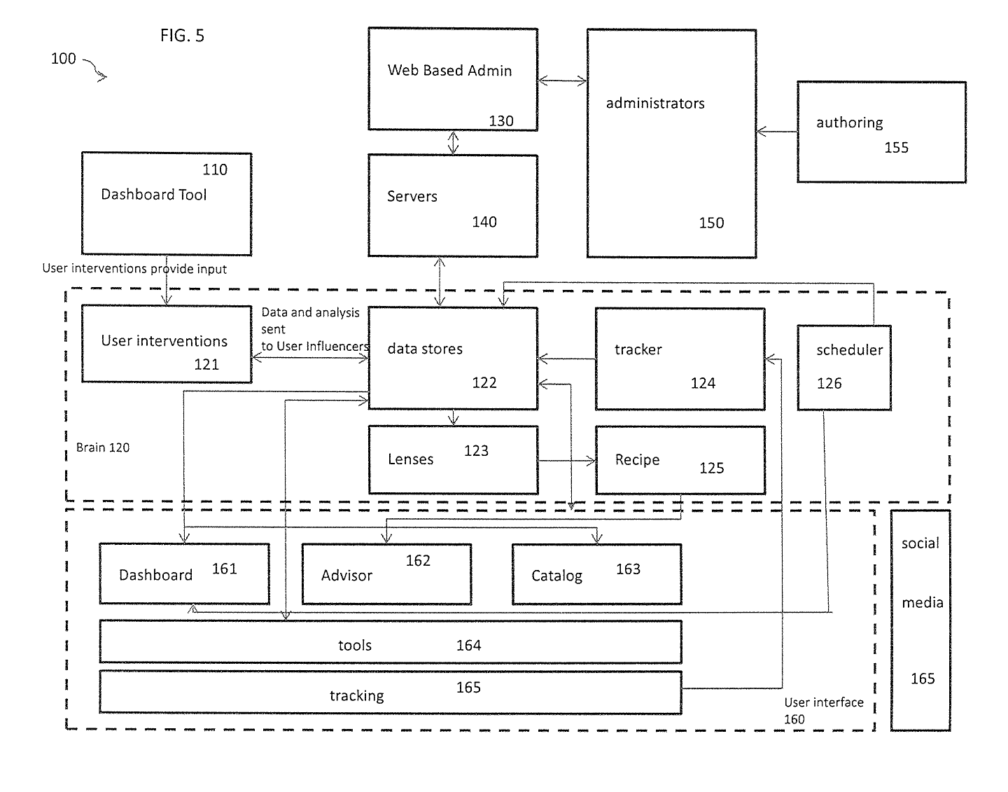

FIG. 5 illustrates a system 100 according to an exemplary embodiment of the invention. The system includes a dashboard tool 110, a brain 120 (e.g., an analysis engine), a web based administration tool 130, a server tool 140, an administrator tool 150, and authoring tool 155, and a user interface 160.

In an exemplary embodiment, the brain 120 employs an ensemble approach to modeling the training of an individual or a group. In the ensemble approach, numerous models involving different techniques and dimensions of data are created and run. The combination of models may be different for each company and for each context. Further, the combination of models and the models used in the combinations can dynamically change over time.

The results of the models can be combined through various manners such as use of a parametric linear equation, a Bayesian model combination, Gaussian mixture models, and Random Forests. Each model can be scaled by a weighted factors based upon human judgment. This allows an educator or individual to place greater or lesser emphasis on a given factor rather than adhering to a fixed recipe.

The features that are considered by each model may be influenced by unsupervised analysis of the data using methods such as clustering. Features may also be chosen by techniques such as Principle Component Analysis where a subset of the most important/influential dimensions (features) are considered. Initially, a subject matter expert may be choose a subset of the features such as difficulty, time, social involvement, etc. As data is collected, the model can be modified. The weighting parameters may be adjusted and one or more variables may be added or removed.

In order to combine these models, a normalized representation of data in the form of feature vectors can be created. The system 100 can perform generate this normalized representation using techniques involving non-negative matrix factorization and by relying on dimensionality reduction through principle component analysis. A similarity between feature vectors can also be calculated using various methods such a Euclidean distance. For models utilizing similarity measures between feature vectors that involve binary values, the system can be configured to swap in an alternate similarity measure. For example, Jaccard indexes can be used to look at the proportion of shared features relative to the total number of features.

Backend data pertaining to content, users, and user activity is stored in a variety of mechanisms that account for different characteristics of the data along dimensions such as structured hierarchical data vs. unstructured data. Some data may be stored in more than one representation (e.g., an SQL based database, a NoSQL based database, a graph database, etc.). The system 100 is setup so that data can be shared within the system, imported from external systems, and exported to external systems.

In an exemplary embodiment, data is transported using RESTful web services or bulk transfer of data via secured file sharing such as SFTP. The system 100 is deployed in a manner to support scalability and can adapt based on usage.

Learners and administrators can also customize these models. This allows a wide range of administrators, trainers, educators, and end users the ability to customize the recommendations provided to better target their specific content or need.

In an exemplary embodiment, the content difficult of training content provided by the system 100 changes dynamically based on current data. For example, assume a user with a 1200 skill level in a given skill is expected to answer a question of 1400 difficulty incorrectly. If the user answers the question correctly, the brain 120 can automatically adjust the difficulty of the question downward. For example, assume the brain 120 adjusts the difficulty of the question downward to 1300. Then, the next time this question is asked to a new user, the new difficulty is used to assess that new user.

The brain 120 is configured to generate training content based on a dynamic model of a combination of different but orthogonal goals. For example, the goal of the company could be to keep cost below a threshold while the goal of the individual could be to increase their skill in a given skill to an expert level. When both goals are considered, it could be determined that the only training content that is economically feasible is training that is designed to increase the level of the employee to a competent level. Thus, rather than consider a single goal in determining content to recommend, the brain can consider multiple goals. Further, the system 100 enables different weights to be applied to each of these goals. For example, an administrator could indicate to the system 100 through a user interface that the employer goal(s) are to be weighted 3 times more than the employee goal(s).

The brain 120 can filter the candidate activities designed for improving the given skill to a subset that accomplishes the goals of both parties. This subset could be selected using a game theory based calculation including Nash Equilibriums that attempt to minimize dissatisfaction of the learner for worst case suggestions as opposed to maximizing benefit to the company without regard to users.

The brain 120, when determining training content for a user, is configured to consider future need based on outside information about parties the user interacts with. For example, the brain 120 can access a scheduling program of the user (e.g., GOOGLE CALENDAR) to determine customers of the user, and analyze purchase history of the customers and/or published works of the customers to predict areas of customer interest. As an example, the published works can be determined by searching the Internet for Blogs and social posts by those customers. These areas of interest are then compared to the salesperson's proficiency levels in skills associated with the areas of interest to identify any skill gaps, and then training to fill these skill gaps is recommended to the user.

The system 100 may be configured to perform classification predictive analysis through a number of modeling techniques including both linear and non-linear discrimination in induction and clustering. The system 100 can rely on numerous techniques such as LogRegression and the use of Support Vector machines. The system 100 may employ various clustering models including centroid models (k-means), density models (DBScan), Agglomerative (bottom up), and Divisive (top-down). Various metric may be used such as a Euclidean distance to a Mahalanobis distance and other measures of group membership such as Jaccard indexes.

In an exemplary embodiment, the brain 120 is located on a central server (e.g., see training system 100 in FIG. 1) that is located remote from remote access devices such as 102, 103, 104, or 105 across the communication network 101. The central server may be a cloud based server. In an exemplary embodiment, at least a part of the web based administration tool 130, the dashboard tool 110, or the user interface 160 is a client program that is located on, and executes on one of the remote devices 102-105. The client programs are configured to interface with the central server.

The brain 120 includes a user intervention tool 121, data stores 122, a lens tool 123, a tracker tool 124, a recipe tool 125 (e.g., a tool to generate rules), and scheduler 126. The brain 120 is located within the central server.

The user interface 160 includes a dashboard 161, an advisor interface 162, a catalog interface 163, other interfaces to various tools 164, and a tracking interface 165. For example, a user can launch the user interface 160 on a tablet 102 that is located remote from the central server.

The scheduler 126 can access data from the data stores 122 and integrate social media data from social media sites 167 such as FACEBOOK, TWITTER, LINKEDIN, etc. The social media data can be retrieved across network 101. The scheduler 126 can analyze the data in the data stores 122 to determine whether a user is having a meeting with a one or more clients in the near future (e.g., within the next few hours), so it can pull up all information relating to the attendees of the meeting from all available sources (e.g., the data stores, social media sites 167, etc.), and display all connected information. The connected information (e.g., reports) can be pushed from the central server to a user device for display on the user device. For example, a tablet 102 of a user may receive a push message from the central server (e.g., the brain 120) including the connected information and the user interface 160 can present the connected information to a display of the tablet 102. In an exemplary embodiment, the push message is formatted using a push access protocol.

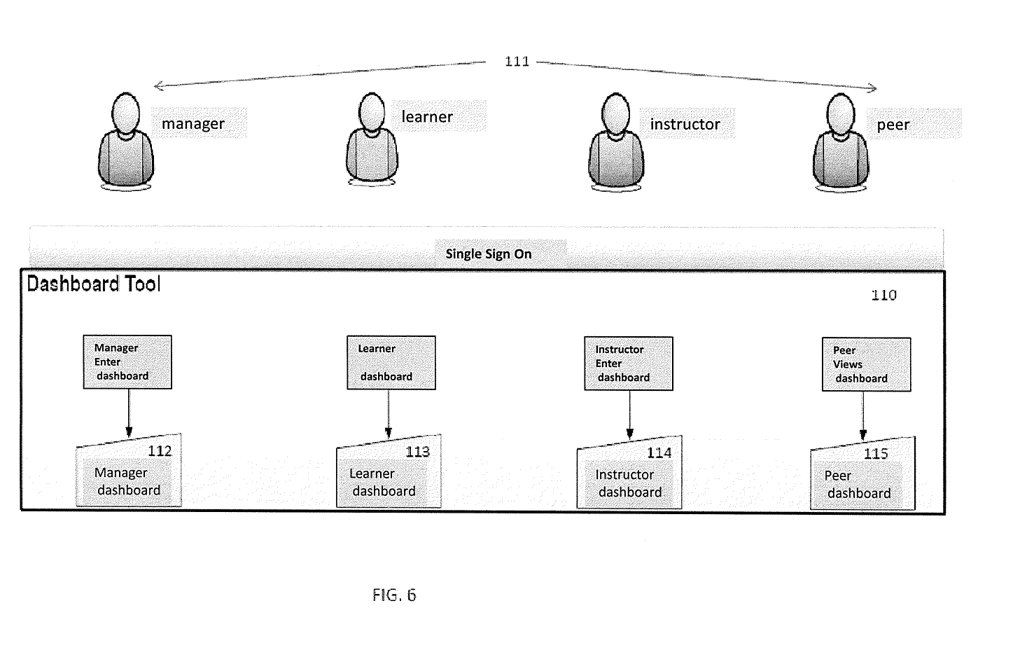

As shown in FIG. 6, the dashboard tool 110 may provide access to various users 111, including a manager, a learner, an instructor, and a peer, with dashboards 112, 113, 114, and 115, respectively. The users operating one of the remote devices (e.g., 102, 103, etc) may access the dashboard tool 110 remotely. Interventions by the users 111 through their respective dashboards act as inputs into the data stores 122. The manager may be a role assigned to an individual or a group of people who in a business context supervises learners. The manager can author, recommend, and require content, and evaluate learners.

Referring back to FIG. 5, the data stores 122 retrieve the appropriate content and process them through a set of lenses 123, the lenses 123 build the optimum courseware and pushes the system (e.g., the brain 120) to generate recipes 125, and the tracker 124 monitors and records to a database (e.g., 122) information detailing all aspects of the user's interaction. The tracker 124 can monitor and analyze learning of the user and behavior of the user.

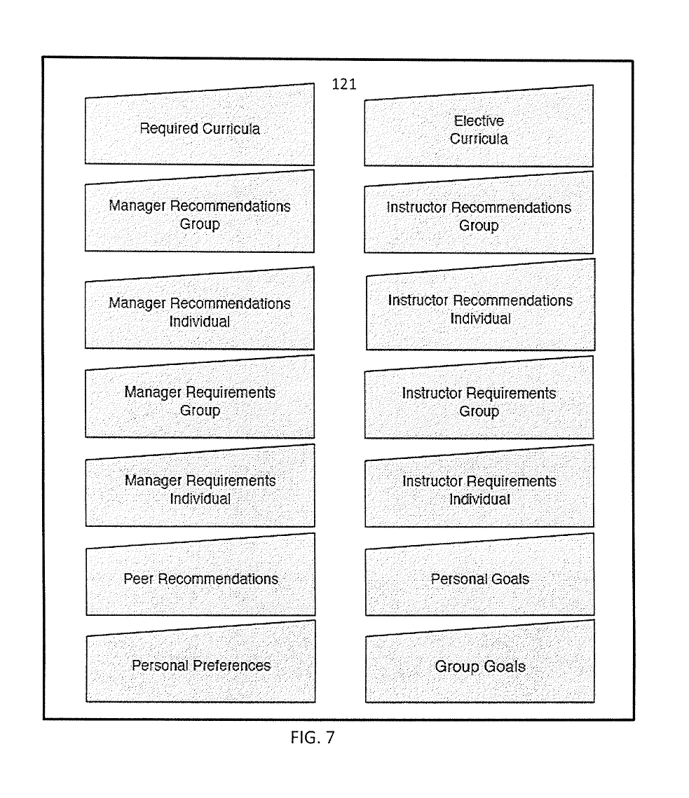

The user interventions tool 121 provides users 111 access to various data, The which is illustrated in FIG. 7 such as required curricula, elective curricula, manager recommendations for a group, instructor recommendations for a group, manager recommendations for an individual, instructor recommendations for an individual, manager requirements for a group, instructor requirements for a group, manger requirements for an individual, instructor requirements for an individual, peer recommendations, personal goals, personal preferences, and group goals. The various data described above may be presented on a remote user device (e.g., 102, 103, etc.). A manager requirement applies to all users working under the manager.

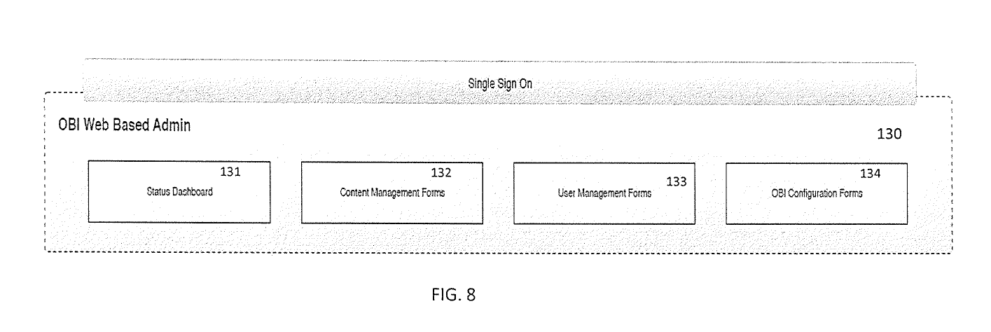

The web based administrator tool 130, as shown in FIG. 8 provides a status dashboard 131, content management forms 132, user management forms 133, and configuration forms 134. The web based administrator tool 130 may be accessed using the remote user devices (e.g., 102, 103, etc.).

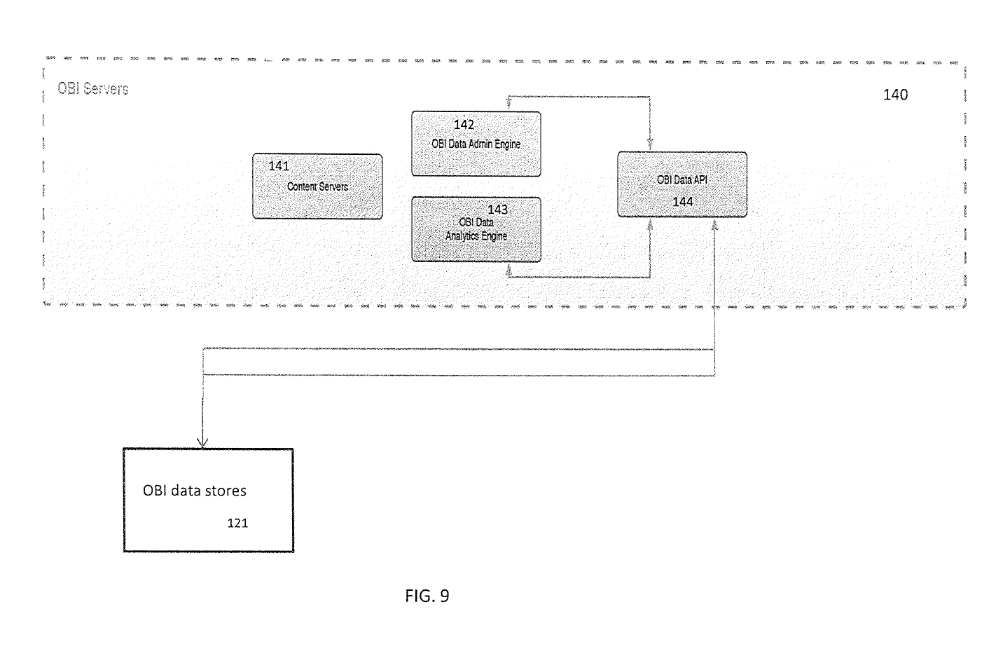

The servers tool 140, as shown in FIG. 9, provides content servers 141, a data administration engine 142, a data analytics engine 143, and a data application program interface 144 that interfaces with the data stores 122.

The data stores 122 may store the required/elective curriculum, the manager/instructor requirements/recommendations, peer recommendations, personal goals, all tracked data, user history, user proficiencies, learning plan, enrollments, user assessments, group assignments, path use preferences, all media (e.g., sound, video, and text files), activity movement preferences, human interaction preferences, instructor/manager assignments, time preferences, object interaction preferences, user data, influence preferences, activities, keywords, group goals, stated preferences, skills, categories, tool use preferences, location preferences, social preferences, LMS, E Performance, Recipes, Individual goals, proficiency ratings, assessment scores, object interaction preferences, modality preferences, human interaction preferences, augmented reality score, e-books, immersive classrooms/learning labs, interactive videos, micro-applications, online classrooms, webcasts, single player simulations, immersive single/multi player simulations, SCORM media, hybrid single/multi player simulations/immersives/immersive-simulations, serious games, virtual courses, webinars, live events, onsite event applications, podcasts, notes, bookmarks, notifications, search results, log of chat messages, message board, study cards, shared data, scoreboard, simulations authored, etc. The data of the data stores 122 may be accessible via the remote user devices (e.g., 102, 103, etc.).

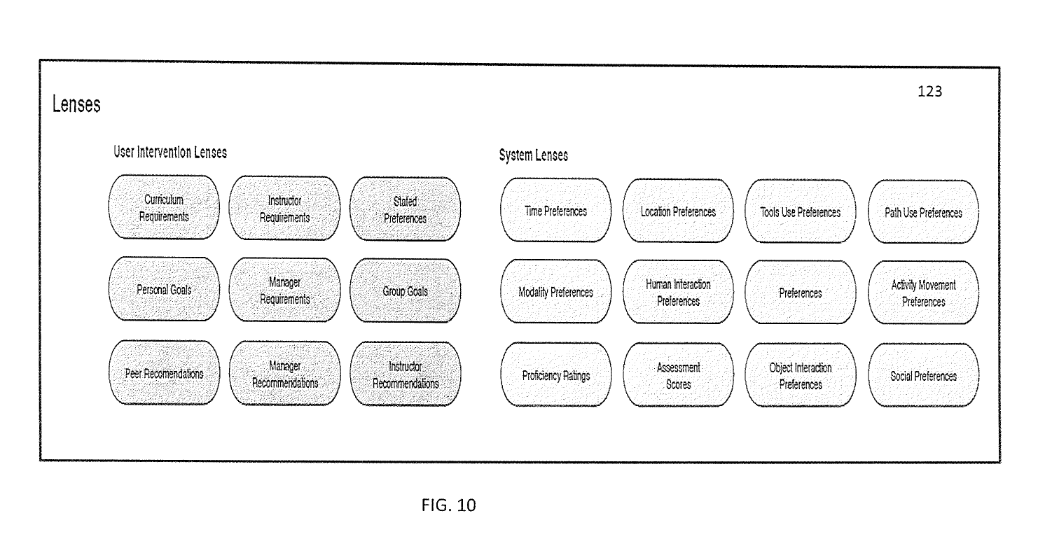

The lenses tool 123, as shown in FIG. 10, provides user intervention lenses on curriculum requirements, instructor/manager requirements, stated preferences, personal/group goals, peer/manager/instructor recommendations, and system lenses on time/location/tool use/path use/modality/human interaction/activity movement/object interaction/social preferences, proficiency ratings, and assessment scores. A lens may be a dimension or characteristic, for which the brain 120 can segment the data store (e.g., 122) and includes, but are not limited to user inputs, ELO rating from peer-to-peer serious game, keyword and category matching, CAT proficiency, Naïve Bayesians Classifiers for induction models.

In an exemplary embodiment, the Brain 120 uses an ELO rating system to assess the skill level of a user. When ELO is used to rank chess players, when one player beats another player, the ranking of the winner goes up and the ranking of the loser goes down. The amount that each player's score goes up or down may be based on the relative rankings among the players. For example, a highly ranked player beating a lowly ranked player could cause a very small increase in the score of the winner and very small decrease in the score of the loser, whereas if the opposite occurred, the increase and decrease would be much higher. The ELO rating system can be applied to rank skill of a user by making certain adjustments. For example, a competency (skill level) of a user can be treated as the ranking of a first player, and the difficulty of the question that the user is about to be asked could be treated as the ranking of the second player. If the user answers the question correctly, their skill level increases, and if the user answers the question incorrectly, their skill level decreases. The amount of the increase and decrease is based on the relative difference between the user's current skill level and the difficulty of the question. For example, if the user is currently assessed at an 1200 and answers a question with a 1250 difficulty, their score might only go up 40 or 50 points, whereas if they answer a question with an 1800 difficulty, their score might go up 200 or 300 points.

The choice of lens and recipes may be weighted toward Bayesian techniques such as Bayesian Inference. For example, a proficiency in many areas may be tracked and reported separately. Instead of storing a single value, the system 100 can maintain a probabilistic approximation of a proficiency level, which is updated continuously with new evidence/data.

The lens may include collaborative filtering models using both person-person, item-item, and implicit observation approaches. Social interaction influences many lenses through areas such as link prediction and social recommendation, which may be modeled through numerous social network analysis techniques such as graph databases and the measures of homophily, centrality, density, strength, mutuality, clustering coefficients and cohesion. Lenses can use models for association rules utilizing measures of lift/leverage and employ algorithms such as Apriori. Another call of lenses may involve Neural networks geared toward identify learning pattern recognition of learner content use.

The lens tool 123 enables the system to present a certain segment of the available data. For example, other segments of the available data can be filtered out so only what is set in the lens is viewable by a remote user device. The lens tool 123 can be configured to perform an analysis or an assessment on a certain segment of the data (e.g., data only associated with a certain group of users, only a certain type of data associated with the user). The lens tool 123 may also be configured to rate or grade a certain segment of data (e.g., only the results of a certain group of users, only the results of a user in a certain learning modality, etc.).

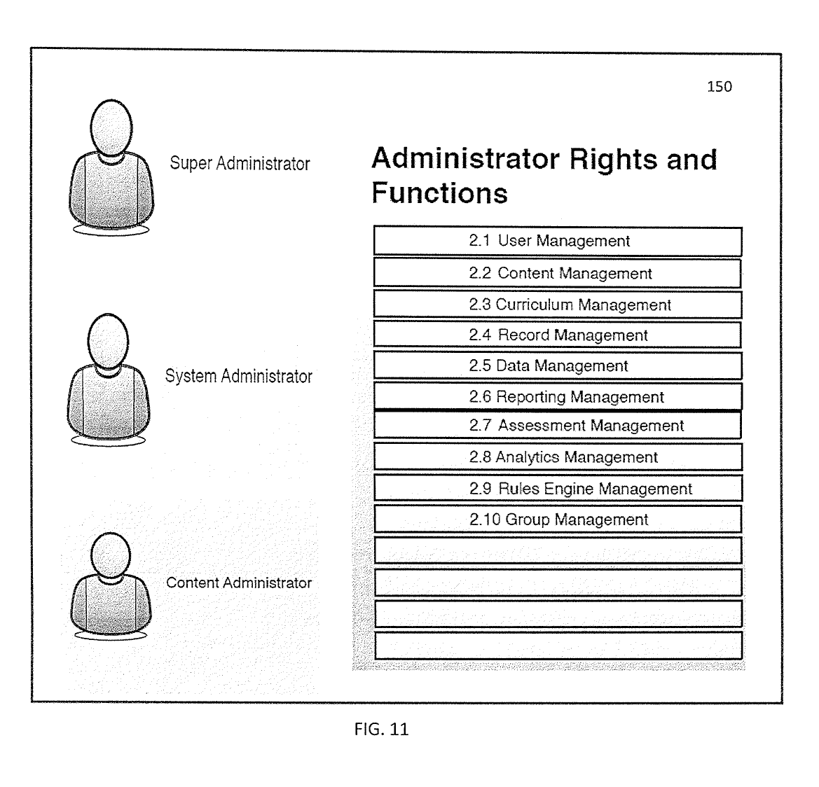

The administrator tool 150, as shown in FIG. 11, provides access to users with higher privileges such as a super administrator, a system administrator, and a content administrator. The administrator tool 150 may be accessible by a remote device (e.g., 102, 103, etc.) using a client program.

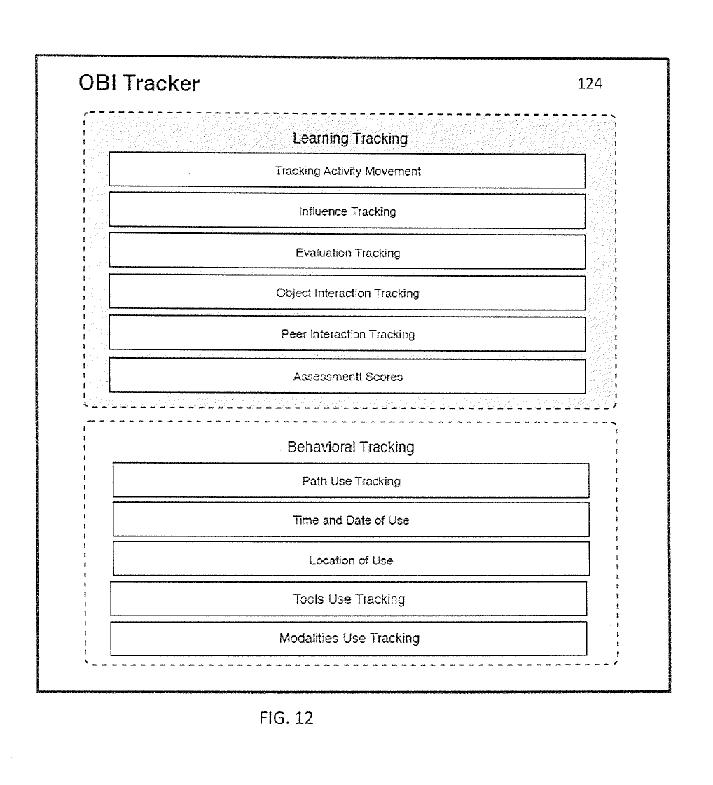

The tracker 124, as shown in FIG. 12, provides learning tracking and behavioral tracking. The learning tracking may include tracking activity movement, influence tracking, evaluation tracking, object interaction tracking (e.g., tracking of interaction at a fine grained level within an activity such as looking up a word definition in an e-book or interacting with an avatar in a simulation), peer interaction tracking, and tracking of assessment scores. The learning tracking can monitor and measure a learner's decision patterns during their work on learning activities and their social interactions with peers and instructors with the purpose of predicting and optimizing learning paths, introducing remediation solutions, and evaluating learning and knowledge transfer. The behavioral tracking may include path use tracking (e.g., tracking of a learner's navigation within a specific activity), time and date of use tracking, location of use tracking, tool use tracking, and modalities used tracking. For example, with an e-book, the tracker 124 can track time spent on a page, which words are highlighted, if the user zooms in on a picture, takes notes or recommends the book.

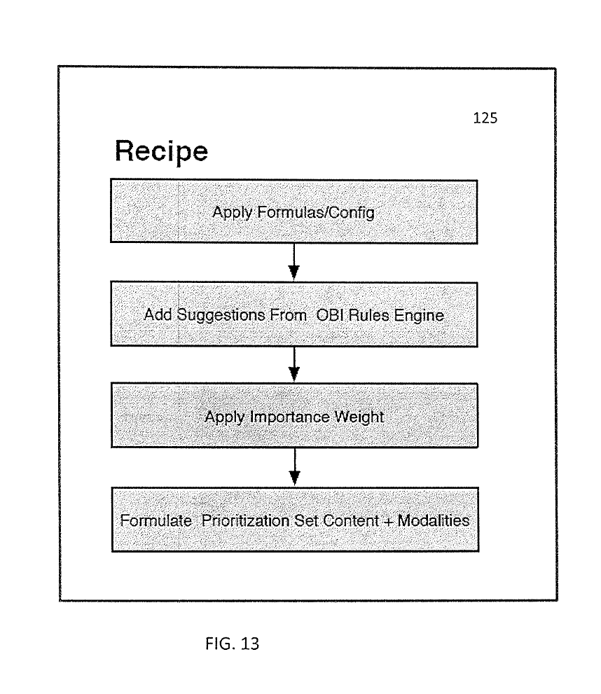

The recipe tool 125, as shown in FIG. 13, can perform a process that include steps such as application of formulas, addition of suggestions from a rules engine, application of an importance weight, and formulation of a prioritized set of content+modalities. Unstructured content such free form textual user generated content can be included in recipes through the use of techniques such as sentiment analysis, which relies on techniques such as topic modeling, named entity extraction, and TFIDF calculations.

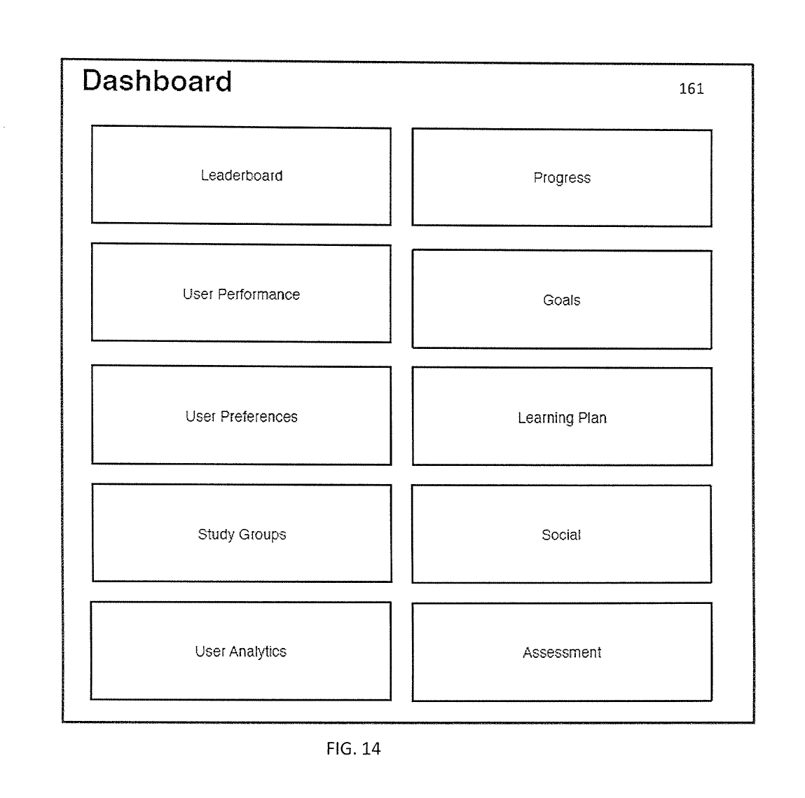

The dashboard 161, as shown in FIG. 14 may provide access to user data such as a leaderboard, user progress, user performance, goals, user preferences, learning plan, study groups, user analytics, user assessments, etc. The user data may be stored in the data stores 122 of the central server and output to the remote devices (e.g., 102, 130) for presentation on the remote devices.

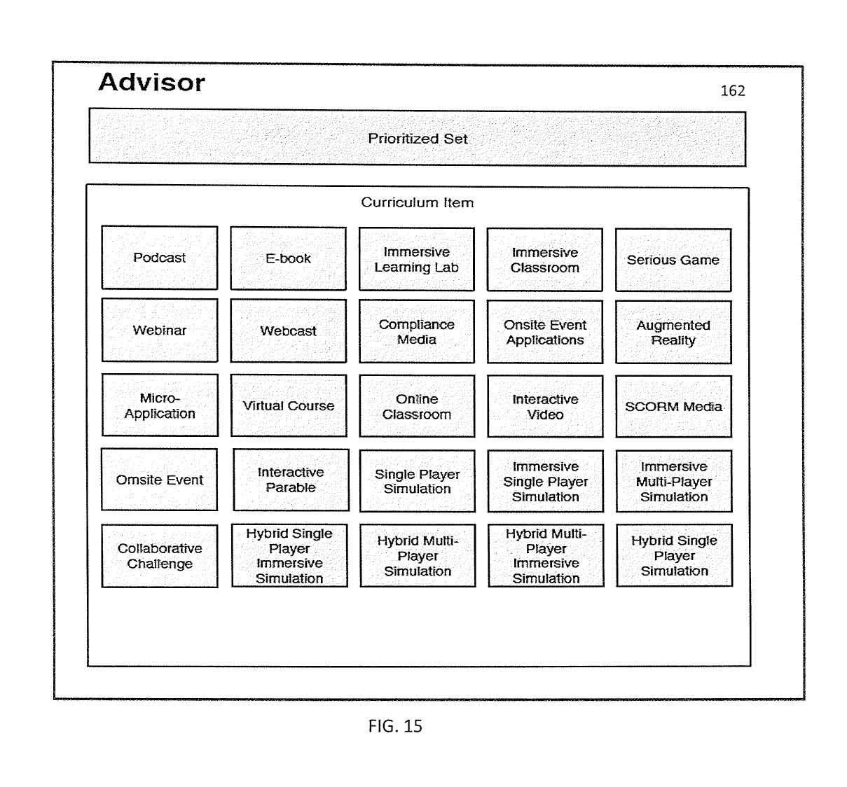

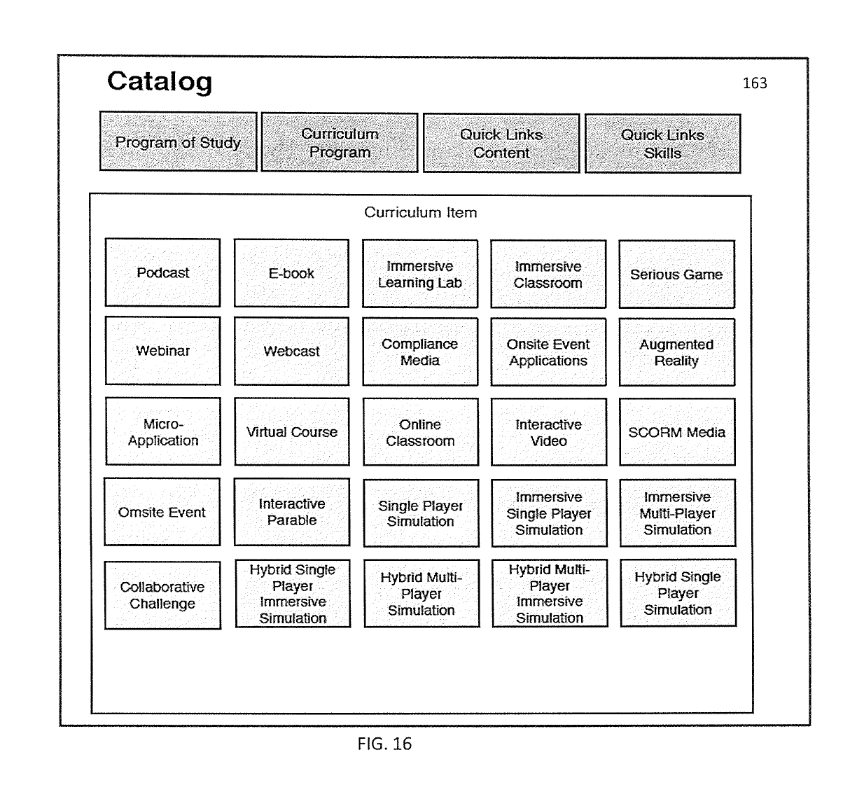

The advisor 162, as shown in FIG. 15, may provide access (e.g., to a user of the remote device) to the prioritized set of content or modalities advised for a user, which could include at least one of a podcast, an e-book, an immersive learning lab/classroom, a serious game, a webinar, a webcast, compliance media, an onsite event application augmented reality, micro-application, virtual course, online classroom, interactive video, SCORM media, onsite event, interactive parable, single player simulation, immersive single/multi player simulation, collaborative challenge, hybrid single/multi player immersive/non-immersive simulations, etc. The catalog 163, as shown in FIG. 16, may provide access (e.g., to a user of the remote device) to the program of study, the curriculum program, quick links content, quick links skills, which could include at least one of the above-described content or modalities.

The other tools 164 may provide functions to users (e.g., of remote devices) such as universal notebooks, message boards, notifications, study cards, status, study groups, chat, augmented reality, a scoreboard, ability to author a simulation, setting goals, sharing data, setting preferences, searches, etc. The tracking interface 165 provides an interface to users (e.g., of remote devices) for making adjustments to learning tracking or behavioral tracking performed by the tracker 124.

The tracker 124 can track all activities with respect to the dashboard 161 including all clicks made by a user (e.g., a learner), what types of questions the user asks, how long the user spends on a question/topic, etc.

The authoring tool 155 can provide content management or assessment management. A user of a remote device (e.g., 102, 103) may access the authoring tool 155 using a client program.

A learner can use the learner dashboard 113 to initiate an advisor session. The learner dashboard 113 can be launched on a remote device (e.g., 102, 103, etc.) of the user. The Advisor 162 displays a list of requirements and activities that the user can choose to fulfill. The user has the ability to filter and modify Advisor 162 suggestions (excluding required training) to create a more targeted list. The Advisor 162, in real time, updates the displayed list of recommended activities based on new criteria specified by the user and sends the list to the recipe tool 125, which becomes the added suggestions. The user then launches the activity in a chosen modality on the user device.

An administrator can launch (e.g., from a remote device) the web-based administration tool 130 for adding required curricula. The tool 130 adds any new metadata (e.g., indicating a difficulty, length, category, keyword, program affiliation, target audience), if necessary, to describe the new requirement or update to an existing requirement. Examples include addition of a high level category, addition of a tin can verb, addition of a new keywords, etc. The tool 130 applies any new metadata, if necessary and specifies details of requirements such as viewing a specific webcast covering a new company policy or specifies a timeframe to complete an activity such as a deadline for viewing the webcast. An instructor or a manager may be notified of new company wide requirements. When the user launches an activity, the instructor or manager may be notified of a recommendation or use by the user of the activity.

An administrator can launch the web-based administration tool 130 for adding elective curricular data. The tool 130 adds any new metadata, if necessary, to describe the new elective curricular data or update to an existing elective curricular data. The tool 130 applies any new metadata, if necessary and specifies details of requirements such as specifying required activities verses a list of activities to select from or specifying the passing score of the evaluation, or specifies a timeframe to complete an activity such as a deadline for completing a certain number of hours of training. When the user launches an activity, the instructor or manager may be notified of a recommendation or use by the user of the activity. A manager can launch the web-based administration tool 130 for adding manager required curricular data. The manager uses the tool 130 to select content, specify a timeframe for viewing the content, and choose users or user groups to store manager requirements for an individual in the user interventions 121. The manager can use interactive features of the dashboard to focus on different aspects of the user's progress and adjusts report properties such as timeframe and choice of proficiencies to measure.

An instructor can launch the web-based administration tool 130 for adding instructor required/recommended data. The instructor uses the tool 130 to select content, specify a timeframe for viewing the content, and choose users or user groups to store instructor requirements/recommended data for an individual in the user interventions 121. The instructor can use interactive features of the dashboard to focus on different aspects of the user's progress and adjusts report properties such as timeframe and choice of proficiencies to measure.

An peer can launch the web-based administration tool 130 for adding peer recommended data (e.g., recommendations of specific content from another learner). The peer uses the tool 130 to select content, add activity to a recommendation list, and choose users or user groups to target the recommendation for storage as peer recommendations in the user interventions 121. The manager/instructor may be notified of the recommendation and when the targeted user engages in the recommended use. A user can add a personal plan or a goal by using the dashboard tool 110 to define individual goals.

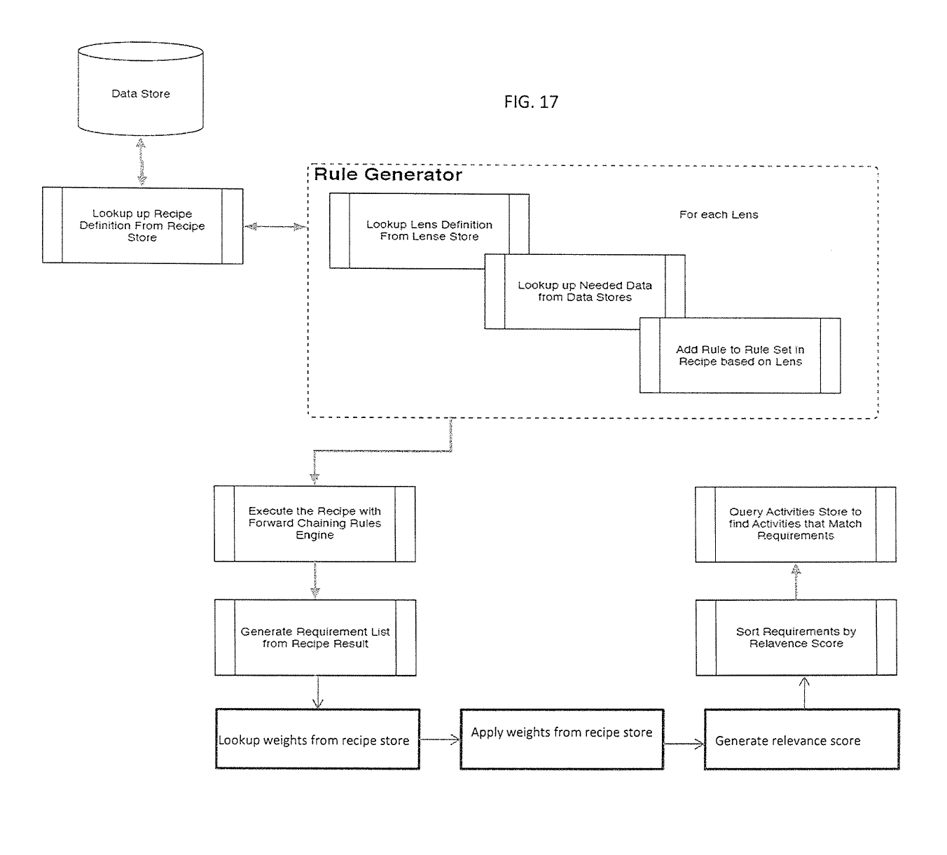

FIG. 17 illustrates a process using a recipe of the recipe tool 125 to determine activities to recommend according to an exemplary embodiment of the invention. The process includes: retrieving a recipe definition from recipe storage; for each lens, using a rules generator to lookup the corresponding lens definition from lens store; looking up needed data from data stores (e.g., 122), and adding a rule to a rule set in recipe based on the lens. The process may be performed by the Brain 120. The process further includes: executing the recipe with a forward chaining rules engine using the rule set; generating a requirement list from the recipe result; looking up weights from recipe storage; applying the weights; generating a relevance score; sorting requirements by the relevance score; and querying activities stored to find activities that match requirements.

In an exemplary embodiment, the Brain 120 provides an assessment engine, which maintains of pool of questions for accessing user proficiency. Each question has a database record and a series of related records in a series of 1 to many relationships serving different purposes. The database record associated with the question may include a question identifier (e.g., QuestionID) identifying the question, a Question difficulty (e.g., a float ranging from 1 to 100), an Optional value for CAT testing (e.g., a float), a Primary category, Keywords, etc. A question can have 0 or more real record points to a location with content. For example a question may appear in an eBook. If a user answers the question wrong, the user may be given the choice to review the material. The records specifies where in the eBook to navigate to. The database record associated with the question may include a reference (pointer) to the question media required to display the question, an explanation of the question (e.g., in HTML).

The question format may be wireframed in the eBook wireframe. The question format may include multiple choice, drag and drop to predefined area that are part of an image, fill in the blank, choosing a value from a slider, ranking/ordering items, yes/no checkboxes, free text response entry areas, etc. Questions may include the ability to display a picture.

The system supports non-adaptive assessments. The assessment may be stored as a single assessment record. The assessment record can have multiple sections. Each section can have a series of 1 or more individual questions. The assessment itself can have an optional instruction page (HTML) shown before the assessment and each section can have an optional instruction page. Each section can have an optional time limit. For example you might have a two section test, where the first section has 3 questions and the second section has questions, where such section has an instruction page. The simplest assessment is a single question which is internally represented by an assessment without instructions and 1 section without instructions. The single section consists of 1 question of a given id.

The system also supports adaptive assessments, such as a computer adaptive test (CAT). The system assigns a person a proficiency in a skill, and asks them several questions. For example, the questions may be sent from the Brain 120 to a user device (e.g., 102, 103, etc.). Based on their answers, the system (e.g., Brain 120) changes its evaluation of the person with respect to their proficiency in one or more skills. Their proficiency in a given skill may be represented using a Bayesian style approach, where a function is maintained that represents the probability that a user has a given skill based on all prior information. To simplify calculations and storage, the function can be stored as an array of several values (e.g., 1000).

In an exemplary embodiment, the questions are ones that an average person would have a 50% chance of getting correct. For an ideal question there is a predictable relation below that describes the probability P of a given person with a given proficiency to answer it correctly.

$$P ( θ ) = \frac{1}{1 + {e}^{a ( θ - b )}} .$$

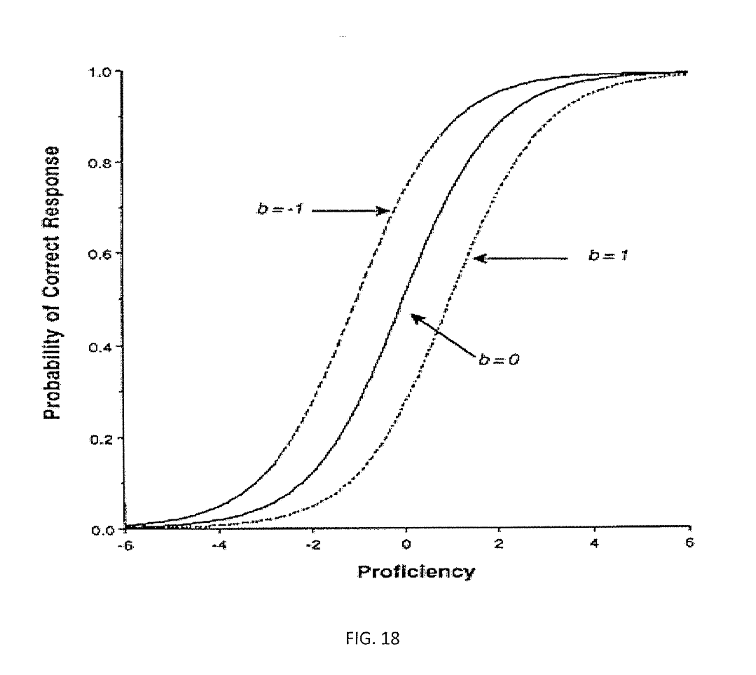

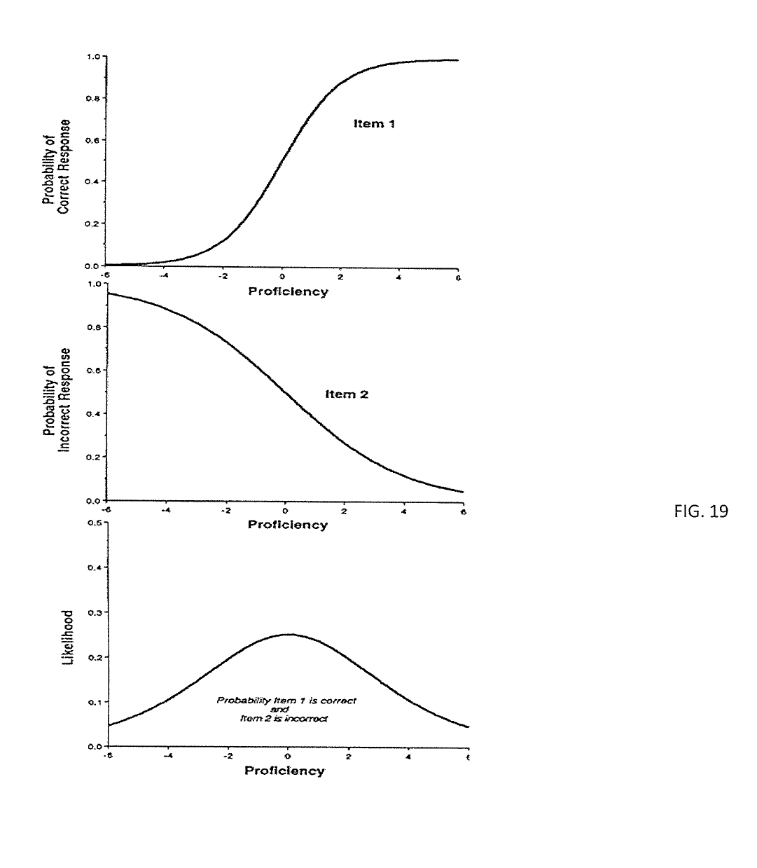

FIG. 18 shows a plot of this probability against proficiency. The plot can be used to determine the point the inflection point) at which a user has a 50% chance of answering the question correctly. So a question with a difficulty of ‘ID’=−1 is best for a user of proficiency −1 and a question of difficulty ‘b’=0 is best for a proficiency of 0. So if the ‘s’ like curve represents the probability of getting a question right, then the inverse (backward s) represent the probability of getting a question wrong. According to Bayes Theory, the probability of getting question correct and incorrect can be found by multiplying the first two curves of FIG. 19 together. At any given time, the most likely proficiency for the user is the local maximum of the curve, shown in the third curve of FIG. 19. The width of the curve represents the certainty of the question. So in a CAT test, one can keep asking the question until the uncertainty (curve narrows) drops below a certain value.

The math to multiply curves can be simplified. As an example, you can represent the curve as an array of several values (e.g., 100) ranging from −3 to 3 in increments of 0.06 ( 6/100). If a user answers a question correctly, the probability P is calculated for each value. Then the array is updated by multiplying the old value by the new one. If the user has answered the question incorrectly, the inverse equation would have been used.

To determine the next question asked, the max value of the array is determined, and a question is asked from the available questions that the user has not seen whose difficulty most closely matches the highest probability proficiency. In the case of a tie, the more difficult question is asked.

At the end of the test, a weighted average is calculated to get the proficiency. For example, the weighted average may be calculated by taking the sum of multiplying the value for the entry in the array by the proficiency it represents and dividing the result by the number of values in the array (e.g., 100).

In a test that mixes skills (tests multiple skills), this calculation is performed separately for each skill. In this case, a pattern is defined. For example, if one wants to ask a 20 question test with questions about category x and z, a pattern such as [x,x,y,y,x,y,y,y,x, . . . ] could be defined.

In an exemplary embodiment of the invention, CAT uses Item Response Theory (IRT). There are 1, 2, and 3 parameter models. In an embodiment, a 1 parameter model is used. The probability of a person of Ability Θanswering a question of difficulty ‘b’ is represented by the below Equation 2.

$$P ( Θ ) = \frac{1}{1 + {e}^{- 1.7 a ( θ - b )}} \qquad Equation 2$$

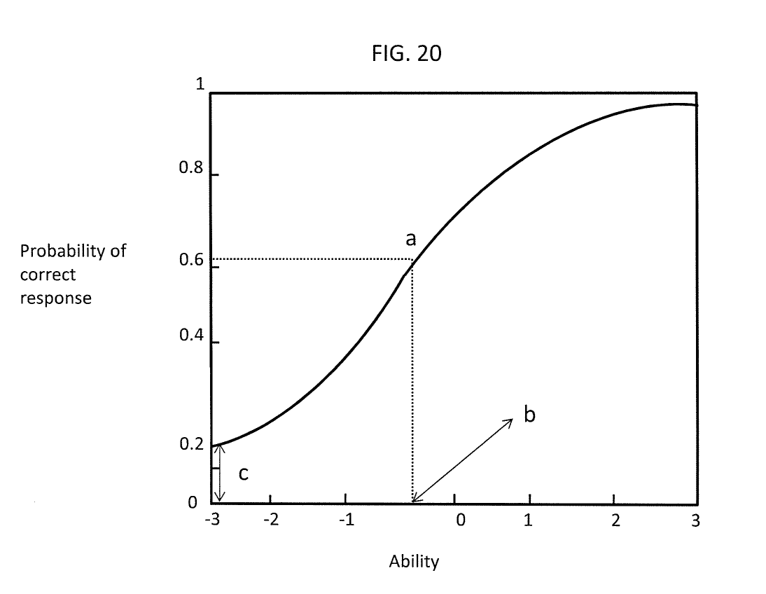

The value ‘a’ represents the discriminating ability of a given question, which could be assumed to be 1 to reduce computation time. FIG. 20 illustrates the probability of getting a correct response verses the Ability. Conversely, the probability of getting the question wrong is represented by the below Equation 3.

$$P ( Θ ) = 1 - \frac{1}{1 + {e}^{- 1.7 a ( θ - b )}} \qquad Equation 3$$

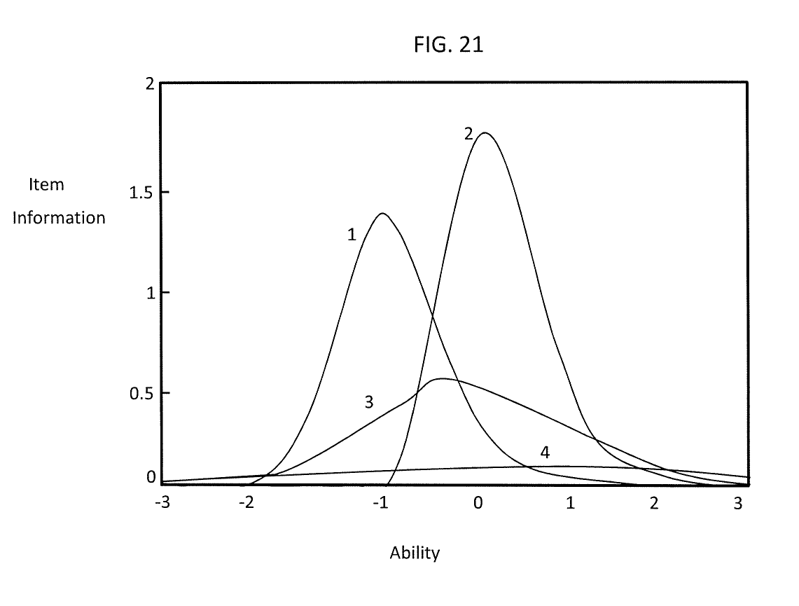

Assuming 1000 values are used for approximating the curve, the system stores an array of 1000 values that represents the probability of that user of a given ability has answered a sequence of questions in a particular fashion. Assuming the user got at least 1 right and 1 wrong the curve will likely follow a Gaussian distribution. The array representing the probability will represent the Bayesian prior. The local maximum will represent the most likely value of their skill and the width of the curve will represent the uncertainty. If a new question is asked, the probability of a correct response can be calculated for every value in the array (e.g., if the rating runs from 0-1000, each array represents 1 rating point). One can then multiply the result by the current value to yield a Bayesian posterior as illustrated in FIG. 21. The initial value of the array can be seeded with a normal distribution with a maximum around the value that one wants to start people at or it can be seeded with values consistent with any prior knowledge of the user. A separate array is stored for every skill of user that is tracked. The basic idea is at any point to ask the question that contributes the most information. In 1 parameter, this is a question that a user of a given ability has a 50% of answering. So if ‘a’ is constant, you can feed a question whose difficulty best matches the current most likely skill level.

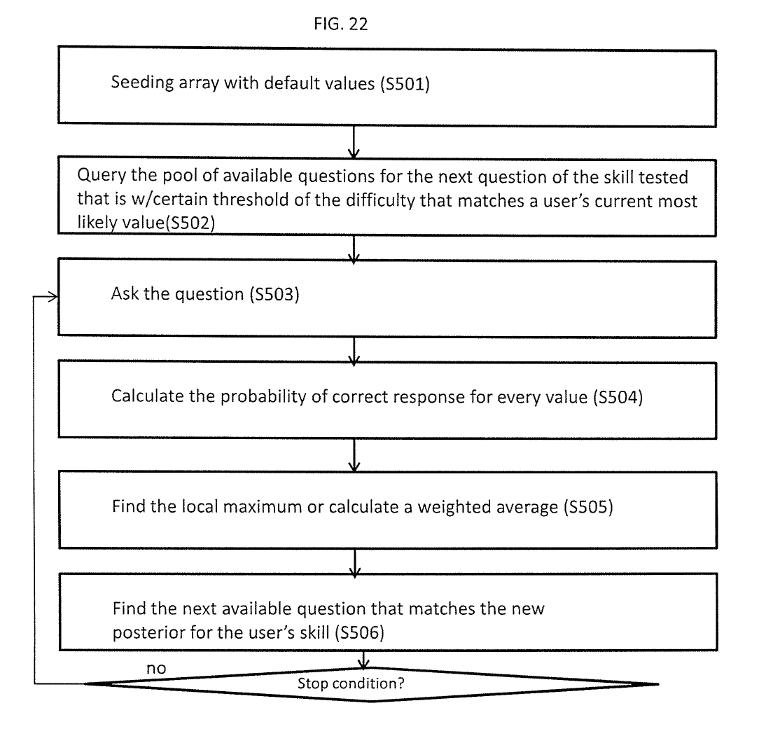

FIG. 22 illustrates a method of determining the most likely value of a user's skill according to an exemplary embodiment of the invention. Referring to FIG. 22, the method includes seeding default values in an array (S501), querying a pool of available questions for a next question of the skill tested that is within a certain threshold of a difficulty that matches a user's current most likely value (S502), asking the user the question (S503), calculating the probability of the user answering the question correctly for every value in the array (S504), finding a local maximum or calculating a weight average of the array to determine a value of the user's skill (S505), finding a next available question that matches a new posterior for the user's skill (S506), and continue to step 503 unless a stop condition is encountered. In an embodiment, the stop condition is encountered after a fixed number of questions have been gone through or the certainty of the skill is above a threshold.

The question pool can be calibrated pre-testing the questions in an unscored fashion against a user base of known skill, and only questions that meet certain criteria are flagged for use in the actual score adaptive assessments. While this may be fine for a formal assessment, in other contexts, it may not be as important to deliver a single constant value. For example, this calibration can be omitted in the context of content recommendation offering a list of activities that improve a skill gap.

The system may be set to use a recipe that suggests content based on a few lenses such as content type, average time for completion of exercises, content covered, and difficulty. In this context, the system is less concerned with the uncertainty of a given score for each item based on the contribution of the difficulty rating for a few reasons. For example, i) the learner is still given a choice of final content, ii) the consequences of choosing an activity over another will likely not have a large impact, iii) in recommendation it is often ranking that is important rather than a absolute measure of differences, and iv) with many factors in the ranking recipe, the weight of a given variable such as difficulty may not be great.

The system offers a spectrum of activity types. They provide a range in ability to report a score based upon a user interaction. On one end of the scale are activities such as Simulations where the learner is continuously evaluated and the activity can report a score, often on a continuous scale. At the other end there are activities such as listening to an audio podcast. It is difficult to directly measure a proficiency score based upon trackable events with the activity. The system deals with this by providing the ability of embedding an assessment (adaptive or linear) or scorable min activity, with any other activity.

If the scorable activities and embedded mini activities and assessments report a score on a normalized scale than a users proficiency on skills can be adjusted after completing each activity using equations such as the ELO or Question Selection Theory presented above. In addition the system could keep a separated calibrated score for use in mission critical evaluation and a separate adaptive score based on usage. An activity may cover more than one skill and each skill may have a separate difficulty rating. A separate calculation is run for each skill. In the end, an activity returns a tuple (order set) of results, rather than a single numerical result.

For example, when an activity such as a Simulation is authored, the author (a subject matter expert) must declare an initial difficulty for each skill. These values could be represented by a Gaussian distribution in a similar fashion as user proficiency is stored. The author would use his judgment for the initial distribution indicating best guess of difficulty and uncertainty. When a user completes the simulation, he is given a score for each skill. This score can be used to update the users proficiency probabilistic curve for each skill. The results can also be used to adjust the probability curves representing the difficulty of the activity for each skill. The adjustment to the difficulty curves do not need to follow the exact form as those used for the users proficiency adjustment. The adjustments prior to a user interacting will tend to be much smaller and in well designed activity, they will quickly converge to values that do not change much. This approach can also be applied to other attributes of the activity. Another factor might be the extent that an activity tests a given skill. Initially the author may declare a contribution value for each skill listed. This contribution could be used to scale the resulting score for a given skill. As more learners participate in an activity, this contribution curve may be adjusted.

The Brain 120 is capable of performing a statistical analysis. A first look at the activities performed by a user (e.g., modalities used, tools used. etc.) produces descriptive statistics, showing how often each modality and each tool is used in relation to a particular skill in a given learning module. The second level of analysis looks at relationships between the modalities and the tools chosen to acquire a skill. The nature of the data dictates the statistic used, so the relationship of data in tables calls for nonparametric statistics, such as a Chi-square, and numerical data leads to multivariate analysis. As the analysis moves to the relationships with learning outcomes and measures of proficiency, inferences emerge about the most beneficial approaches. Finally, the strength of the relationship between learning outcomes and job performance can be used to determine the most suitable content to recommend. The goal is to find the activities within each modality, the associated tools and exercises that produce the best results, in terms of learning outcomes and finally job performance. Each individual can be tracked in this manner, and overall trends analyzed.

As an overview of the statistical techniques that can be used to analyze the data, there are two primary functions, first to describe the data and then to analyze the relationships. The descriptive statistics summarize the data set, and provide insights into the population from which the data derives. The analysis looks at relationships between variables, the users engaged in the learning activities and the way this affects outcomes. Statistical inference allows the system to draw conclusions from the relationships in the data, for display on a dashboard.

Descriptive statistics provide summaries of the data set. They include both tables of observations with summary statistics, or visual, in the form of illustrative graphs and charts. These tabulations of data set allow comparisons, using nonparametric statistics. Some of the summarization techniques permit exploratory data analysis, using a technique such as a box plot. The output appears on a dashboard that frequently updates during the day.

Multivariate data analysis techniques may be used to determine relationships in the data that can be used to develop learning factors, student clusters, predictive models and perceptual maps. The data allows comparisons between the rise and fall of one activity and the rise and fall of the learning results associated with that activity. The analysis flows from the correlations between the variables.

A principal components and exploratory analysis transforms the data into a set of linearly uncorrelated principal components that are predictive and representative of a learning model. The results come from a large correlation matrix calculating the strength of the relationship between each variable.

An exploratory factor analysis reduces the observed variables into a small number of factors plus “errors.” The factors are also predictive and tend to be representative of an underlying learning model.

Given a set N of activities all generating a normalized competency score, and a sample of these N scores across M individuals, these techniques can determine a clustering of activity effectiveness by individual, assuming a significant sampling of different activities. The efficacy of the three learning dimensions (visual, auditory, kinesthetic) emerges from the results as well as the relationships to different modalities. Additional inferences may reveal unknown factors indicated by the data. For example there may be more modalities indicated that are combinations of the activities as well as some unknown environmental factors. Individuals can be assigned a weighting indicating the effectiveness of each learning modality for them based on the results of the analysis.

Cluster analysis, like factor analysis, examines the entire set of interdependent relationships, the other flank of factor analysis. While factor analysis reduces the number of variables by grouping them into a smaller set of factors, cluster analysis reduces the number of cases by grouping them into a smaller set of clusters. This produces groups or clusters of similar students based on their activities, choices and outcomes.

Two predictive models result from the above, one on activities and another for the participants. The first predictive model allows the use of a prescribed set of activities to determine the best learning modalities for an individual, which can then be used to suggest future activities that would be most effective for that individual. The second predictive model allows a sampling of individuals across a number of modalities to perform a new activity, the results of which can be used to assign suitability scores for each modality to the activity.

A perceptual mapping technique groups the data set into a one or more dimensional scale of attributes. For example, an evaluator may be asked to arrange activities on a 2D plot with an x-axis of “cost-effective” and y-axis of “informative”. Aggregated results provide a mechanism to perform analysis against otherwise subjective data. Participants can then be grouped based on learning outcomes in order to better identify the way they proceed through the modalities and the effectiveness of acquired skills.

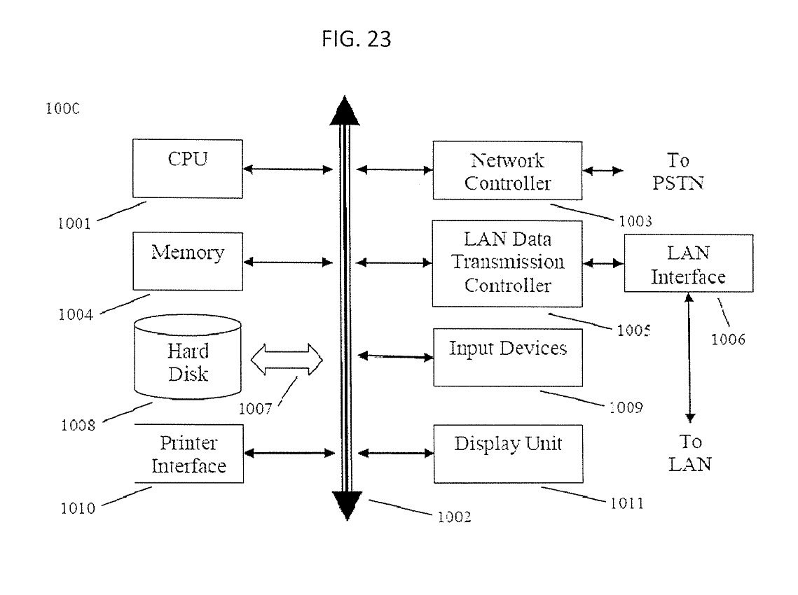

FIG. 23 shows an example of a computer system, which may implement the methods and systems of the present disclosure. The system and methods of the present disclosure, or part of the system and methods, may be implemented in the form of a software application running on a computer system, for example, a mainframe, personal computer (PC), handheld computer, server, etc. For example, the method of FIG. 2 or the units/tools/interfaces of FIG. 5 may be implemented as software application(s). These software applications may be stored on a computer readable media (such as hard disk drive memory 1008) locally accessible by the computer system and accessible via a hard wired or wireless connection to a network, for example, a local area network, or the Internet.

The computer system referred to generally as system 1000 may include, for example, a central processing unit (CPU) 1001, a GPU (not shown), a random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007. CPU 1001 may be the computer processor that performs some or all of the steps of the methods described above with reference to FIGS. 1-19.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

What is claimed is:

1. A learning system comprising:
a memory storing a computer program;
a network interface configured to communicate with remote access devices across a computer network; and
a processor configured to execute the computer program,
wherein the computer program is configured to perform a cluster analysis on groups of users, to predict for each group, a subset of training modalities from among a larger set of learning modalities where the corresponding group has a greater than average rate of improvement in a given skill among a plurality of available skills over a given time period,
wherein the computer program is configured to perform a cluster analysis on a new user and the groups of users to determine one group among the groups the user is most similar to, and
wherein the computer program is configured to present training material across the network on the remote access device of the new user based on the predicted subset of the learning modalities associated with the determined one group.

2. The learning system of claim 1, further comprising a database formatted to map roles to the skills and the users to the skills, wherein the database comprises a roles table, a skills table, and a user table, the roles table including an entry for each role, the skills table including an entry for each skill subdivided into different levels of proficiency, and the user table including an entry for each user.

3. The learning system wherein the roles table is linked to the skills table to indicate what skills are required for each role and the user table is linked to the skills table to indicate what skills each user currently has.

4. The learning system of claim 3, wherein the computer program is configured to enable a user to enter a new role with a set of the skills different from a set of skills currently held by the user in the database, predict training content likely to give the user the missing skills, and present the training content to the user.

5. The learning system of claim 1, wherein the learning modalities include at least one of augmented reality, collaborative challenges, electric books (E-books), interactive videos, interactive parables, podcasts, games, simulations, webcasts, and webinars.

6. The learning system of claim 1, wherein the computer program is configured to determine an optimal set of the learning modalities by a user by comparing performance of the user in each learning modality against a predefined threshold, and selecting those that exceed the threshold.

7. The learning system of claim 6, wherein the computer program is configured to design a learning schedule based on the optimal learning set, where the schedule schedules a length of time to be spent on a given one of the learning modalities to be based on a performance level of the user in the given learning modality.
